(19) United States
(12) Patent Application Publication
(10) Pub. No.: US 2024/0233575 A1
(43) Pub. Date: Jul. 11, 2024

(54) Improved System and Method for Mathematics Education

(71) Applicant: Stewart Lamle, Santa Monica, CA (US)

(72) Inventor: Stewart Lamle, Santa Monica, CA (US)

(21) Appl. No.: 18/563,016

(22) PCT Filed: May 24, 2022
(86) PCT No.: PCT/US22/30735

§ 371 Date: Nov. 21, 2023

Related U.S. Application Data
(60) Provisional application No. 63/192,294, filed on May 24, 2021.

(51) Int. Cl. G09B 19/02; G09B 5/06

(52) U.S. Cl. CPC G09B 19/025; G09B 5/06

(57) ABSTRACT

A system and method for teaching and learning mathematics. The system includes a plurality of modules including a first module having blocks for assembling into different configurations, a second module having a plurality of sheets of predetermined mathematical equations, a third module having a plurality of dice having numbers and mathematical operation symbols, and a fourth module having a deck of playing cards. At least one of the modules is implemented with augmented or virtual reality. The blocks of the first module comprise blocks of differing geometric shapes. The sheets of the second module comprise at least addition, subtraction, multiplication, and division operations. The third module includes dice having a plurality of sides, with two dice having a number on each side and one dice having a different mathematical operation symbol on each side. The deck of the fourth module contains playing cards with numbers on both sides.

### CROSS REFERENCE TO RELATED APPLICATION

The present application claims priority to U.S. Provisional Application No. 63/192,294, titled “Improved System and Method for Mathematics Education,” filed on May 24, 2021, which is incorporated by reference in its entirety.

### FIELD

The present invention relates to mathematics education. Specifically, this invention is a new intergraded suite of math manipulatives designed to work together to improve mathematics education from pre-K to grade 12 as enjoyable physical experiences to develop the skills of observation, logic and creativity in order to improve mathematical thinking and to provide repeatable physical, logical and creative practice in mathematics, thereby reducing math anxiety and increasing proficiency.

### BACKGROUND

The drive to develop our abilities is built into our nature from birth. Learning is part of our human nature, and our animal nature. Learning is so essential that it also exists in plants, fungi, bacteria and viruses.

Numerous studies show that the development of skills is intrinsically rewarding to all children and adults, and we can use our internal reward systems to increase learning. We have powerful, internal reward systems designed to learn and to use that learning because we need to adapt to changing environments in order to stay alive.

The traditional approach to learning mathematics is the direct transfer of math facts and calculation procedures from teachers, computer programs and textbooks to students, followed by repeated practice in using the math facts and procedures in order to answer questions on math tests. This approach has disastrous consequence for math education outcome, and is a danger to society's welfare.

Globally and in the United States, most of the math class time is spent learning how to use math facts and procedures in order to pass math tests. Testing results are external grades on paper and in computers. Thus, since they are external, there are built-in problems with using motivation that is based on learning math facts and procedures, to answers questions on math tests. As a result:
1. The source of motivation is external, thus tests and grades have no clear path to internal, personal rewards.
2. Therefore, students may not feel the grades are intrinsically meaningful, or personally important.
3. External motivators are subject to competing external motivators for time and energy.
4. As motivation to learn, the concept of passing tests and getting graded also contains with in it the fear of failure, which is de-motivating and anxiety producing, especially when fear and failure are repeated.
5. Repetition of unpleasant math experiences, such as tests and low grades, can intensify math anxiety.
6. Students with high levels of math anxiety tend to perceive math tests as extrinsic threats and react defensively out of fear, which reduces their ability to learn.
7. Frequent testing also tends to reduce the perceived importance of any individual test; thus, frequency can further reduce motivation and increase procrastination.
8. Attempts to enhance the largely ineffective use of tests to motivate students usually include, praise or reward for doing well, and guilt or penalty for not. It can be felt as a form of emotional coercion, which can create serious problems.
9. The effectiveness of any external emotional motivator is largely dependent on the complex changing relationships of student and motivator over time, and therefore is often not reliable.
10. We may involuntarily spend time and effort when faced with external rewards and punishments, but since we would rather be doing something else motivation is reduced.
11. For students who are afraid of math, additional emotional pressure is likely to inhibit their ability to learn.
12. A majority of students report some level of math anxiety. Math anxiety and test anxiety are the most common form of anxiety in students.

Around the world, most of the time in math class is spent in teaching “how to use math facts and procedures in order to answer questions on math tests.” The failure of current math education can be seen from the results of The Program for International Student Assessment (PISA), a worldwide study by Organization for Economic Cooperation and Development (OECD) of 15-year-old students' scholastic performance on mathematics, in over 70 nations and jurisdictions.

### Current Global and National Math Education Outcomes

The United States is below the international average in mathematics according to the OECD, PISA 2015 Results (Volume I): Excellence and Equity in Education, Mathematics performance among 15-year-olds, page 192. See, https://dx.doi.org/10.1787/9789264266490-9-en. The US has consistently been ranked below average since the first PISA exams in 2003. The following are global averages of math education outcomes of 15-year-old students, in 2015: 3% of students were demonstrated the ability to think mathematically (Level 6); 8% of students were proficient (Level 5) and above, 92% of students were below proficiency in mathematics; and 12% of student were functionally non-numerate (Level 2 and below). The OECD defines Level 2 as “the level at which students begin to demonstrate the skills that will enable them to participate effectively and productively in life,” and Level 6 as the level at which “students can develop and work with models for complex situations, and work strategically using broad, well-developed thinking and reasoning skills.”

More than a quarter of 15-year-olds, 26%, in the United States are below the PISA Level 2 of mathematics proficiency. By contrast, in Hong Kong-China, Korea, Shanghai-China and Singapore, 10% of students or fewer are poor performers in mathematics. Only 2% of students in the United States reach Level 6 performance in mathematics, compared with an OECD average of 3% and 31% of students in Shanghai-China. It is worth noting that the proportions of top performers in reading and science in the United States are both around the OECD average.

The United States National Report Card on Mathematics shows that as years of education increase, the proportion of students who are proficient in math decrease and the proportion who are below the basic level increase. Below are the USA results for the year 2017, 4th grade and 8th grade, and 12th grade in 2018.

| | 4th grade | 8th grade | 12th grade |
|---|---|---|---|
| % Proficient or above | 40% | 34% | 25% |
| % Below Basic | 20% | 30% | 38% |

Moreover, the U.S. Department of Education statistics also show that 85% of high school students graduated in 2018, but 25% were proficient in 12th grade math, and 38% were not proficient in 4th grade math. See https://nces.ed.gov/fastfacts/displav.asp?id=805. The Department of Education defines proficient skills at grade level as the ability to use math tools to discover solutions to problems and explain why and how they work, and basic skills at grade level as the ability to use, sometimes inaccurately, simple math tools to perform simple calculations, without the ability to explain why or how they work. Clearly, the traditional approach to teaching mathematics, pre-K to grade 12, even when augmented with math manipulatives and computerized technologies, is a failure for most students in the United States and globally.

Teaching math facts and practicing procedures to get answers on tests is the most common actual use of time in pre-K to grade 12 math classes. As a result, the testing industry has grown, but math performance has not.

The performance grading of frequent, apparently objective, benchmark tests of small bits of math can incentivize teachers to teach to the test, and incentivize students to memorize math facts and procedures to pass tests, rather than to learn to think mathematically. It is natural for people to follow incentives. However, “teaching to the test” corrupts the purpose of learning mathematics, which results in bad math outcomes for most students.

In 2018 the OECD explained: “Students in the United States have particular weaknesses in items with higher cognitive demands, such as taking real-world situations, translating them into mathematical terms, and interpreting mathematical aspects in real-world problems.” In the United States, 8% of students scored at Level 5 [Proficient] or higher in mathematics (OECD average: 11%). According to the OECD, six Asian countries and economies had the largest shares of students who did so: Beijing, Shanghai, Jiangsu and Zhejiang (China) (44%), Singapore (37%), Hong Kong (China) (29%), Macao (China) (28%), Chinese Taipei (23%) and Korea (21%). These students can model complex situations mathematically, and can select, compare and evaluate appropriate problem-solving strategies for dealing with them. See, https://www.oecd.org/pisa/publications/PISA2108_CN_USA.pdf.

Regardless of any articulated theory, actual methods of teaching mathematics in the United States and most of the world are based on the actual classroom practice of “learning math in order to pass tests.”

### Motivation

Mathematics is part of education in all grades, pre-K to grade 12, and beyond. To be effective over the long term the motivation must be long-lasting to motivate students to spend the considerable amount of time and effort needed to learn mathematics. Human beings often spend a great deal of time and effort for the chance to learn, discover and engage in something meaningful to them. Usually, we voluntarily spend tremendous amounts of time and effort only: (a) if we enjoy it; or (b) if it is intrinsically important to us for other reasons; or (c) both.

Joy and intrinsic importance are intensely strong and long-lasting internal motivations for actions that require substantial time and effort. The best is both enjoyment and intrinsic importance working together to encourage effort. As stated by Confucius, “I hear and I forget. I see and I remember. I do and I understand.” The benefits of experience-based learning are well-known. They were advocated by Maria Montessori, John Dewey and many prominent educators. Purposeful experience and exploration achieve deeper understanding and greater retention then listening to lectures or seeing demonstrations.

Math manipulatives are designed to create physical experiences of mathematical concepts. Unfortunately, studies show that many teachers often do not use math manipulatives in their usual teaching routine. Instead, if they use them at all, they use them as rewards, because they do not know how to integrate them in their lessons, which are based on using math facts and procedures pass tests. In light of the growing importance of improving mathematical abilities, and clear failure as measured by global and national studies, many instructors and students would benefit from these mathematical thinking learning tools.

Manipulative devices have been developed to aid math learning and performance since civilization made calculation necessary. The abacus was invented more than 2.000 years ago. Over the years many techniques have been devised to learn mathematical skills through the manipulation of real objects. The majority of these are variations on the theme of counting and are used to demonstrate the four arithmetic operations: addition, subtraction, multiplication and division in physical terms.

In the twentieth century, classroom manipulatives were developed specifically to expose young children to basic arithmetic and the properties of the base 10 numbers. For example, Cuisenaire rods (1952) are colored rods with integer lengths to introduce physical, arithmetic to students. In another example, multi-base Arithmetic Blocks (MAB) blocks also known as Dienes blocks demonstrate the size and volume of 1, 10, 100 and 1,000 cubic centimeters. Several U.S. patents also disclose kits and puzzles that utilize blocks and other geometric shapes for the teaching of mathematical skills. U.S. Pat. No. 4,548,585 to Kelly discloses ten shapes each distinctive of an integer from one to ten and each being distinctively colored. The shapes of at least some of the integers are placed together in a composite shape which is the same as the shape of a larger integer to which the smaller integer equals. U.S. Pat. No. 4,585,419 to Rinaldelli discloses an aid for teaching number systems of any base utilizing a series of containers and a number of pieces each representing a numerical unit. For example, the base 10 unit cubes are used to fill up a first box, and 10 such filled boxes are used to make up a larger box, etc.

Much of the prior art are used for answering math problems by representing symbolic concepts with physical objects. For example, placing a 2-length block+a 3-length block to equal the length of a 5-length block represents the same concept as 2+3=5 does symbolically. The major shortcoming of the prior art is that do not address the need to develop a coherent set of observation and thinking processes to improve mathematical thinking and reduce math anxiety.

Assessment and testing are essential to understanding the mathematical thinking, knowledge and skill of students. There are tests that can assess the development of mathematical thinking. However, testing is not learning. The present invention is designed to increase mathematical thinking abilities in students. The present invention is also designed to assist the understanding and practice of observation, logic and creativity, which are the foundation of mathematical thinking.

Studies consistently show that current math educational practices are a failure for most students in the United States, and for most students around the globe. This is partly due to the inappropriate use of testing and grades to motivate students to learn math.

Studies also show that students with higher motivation in a subject invest more time and effort in learning and they apply more effective learning strategies. Game inventors use two types of rewards to entice players and keep them playing: extrinsic and intrinsic rewards.

Extrinsic rewards such as prizes for winning can be wonderful, and the cost for losing can be uncomfortable. The effects of extrinsic rewards are usually not long-lasting, especially when contests are followed by streams of additional contests—as with tests in school. Thus, the extrinsic reward and punishment of tests are likely to be short lasting, and over time are likely to have diminished impact for most students. To some students, just the idea of tests is uncomfortable, and the reward and punishment of tests are often perceived as potential personal threats. Threats are terrible motivators. They energize defense mechanisms, instead of energizing actions to enjoy learning. Testing, and related extrinsic reward systems may have utility in assessing knowledge. However, they are potentially counterproductive. They are not long-lasting motivators, and they are in competition with other external motivators.

Students need motivators that enhance their abilities, both immediately and over the long term, regardless of difficulty. Intrinsic rewards are long-lasting. For example, learning to ride a horse can be fun, but it is also difficult. However even when it is hard, there are intrinsic personal desires and values to be realized. For people who enjoy riding horses, it feels good, it is worth the time, effort and expense, and they want to do it again and again.

On the other hand external rewards and punishments teaches children to behave in certain ways for a reward or to avoid punishment. There are many studies showing that when children expect or anticipate rewards, they perform more poorly. One study found that students' performance was undermined when offered money for better marks. A number of American and Israeli studies show that reward systems suppress students' creativity, and generally impoverish the quality of their work. Rewards can kill creativity, because they discourage risk-taking. When children are hooked on getting a reward, they tend to avoid challenges, to “play it safe”. They prefer to do the minimum required to get that prize.

### Math Anxiety

The need for developing mathematical thinking skills of observation, logic and creativity is great and not confined the field of mathematics. Clear thinking, built on evidence, logic and creative argument are important skills in every field.

For children and adults worldwide, the fear of math, aka, math anxiety, is the most widespread of all anxieties. Math anxiety is a debilitating problem on personal, national and global levels. The feeling of being mathematically incompetent and giving up learning because “it's too hard” is not just a small, isolated problem for a few people. It affects billions of people, children and adults. Math anxiety creates a host of psychological and real-world problems that deprives individuals of educational and employment opportunities, which reduces expected lifetime income, and statistically shortens life itself. On a global level, math anxiety is dangerous. Poorly educated populations without the rigorous tools of mathematical thinking can easily succumb to the salesmanship of testably false ways of thinking. Historically, poor math education contributes to oppression and violent instability, and it is likely to do so in the future.

The motivation of passing tests is external, thus learning to pass tests is a weak form of motivation that tends to decline as the number of tests increase, and as other external motivations compete for attention. In order to make math education more successful for more students, the students must have strong, long-lasting motivation. Mathematics is not learned in a snap; it takes years and at times it will be difficult.

Human beings, animals and plants are always learning and adapting in order to survive.

Growing and learning are strong motivators because they are an integral part of our nature. Human beings are also curious by nature, and that curiosity is a strong motivator. We think and create our own private, internal purposes, which motivates us to action. These internal motivators are powerful and long-lasting. Many know this from personal experience.

Joy, pleasure, growing, happiness, contentment, safety, etc. These are strong, durable motivators because they are inherent to our existence. Internal motivators are usually beyond the reach of competing external motivators. Having fun with this set of tools increases the effectiveness mathematical thinking experiences. Fun reduces the need for defenses against new experiences. While playing and having fun while using these tools stimulates students thinking skills in ways that are enjoyable, and not frightening. Therefore, when Wiz-Math is used in a positive, non-judgmental environment the problems of math anxiety can be reduced.

Anxiety describes the tendency to avoid a task or a situation. Math anxiety is widespread across the globe and for people of all ages. Billions of people have math anxiety. It is humanity's most common anxiety. See, https://www.ncbi.nlm.nih.gov/pmc/articles/PMC6087017/.

Math anxiety is experienced as feelings of apprehension and increased nervousness when individuals deal with math. It manifests itself on emotional, cognitive, and physiological levels that lead to decreased math achievement and reduced self-concept. On an emotional level, individuals suffer from feelings of tension, apprehension, nervousness, and worry. On a cognitive level, math anxiety reduces the functioning of working memory, which is flooded with negative chatter that interferes with the motivation to learn. On physiological levels it can manifest as increased heart rate, profuse sweating, intestinal problems and fainting. People have many ways to say, “I hate math,” “I'm not a math person,” or “I'm no good at math,” and then they stop trying to think, because it is math. Math anxiety is often more than the fear of doing something wrong. It can be the fear of “being wrong” and of “not being good enough.”

Neurologic studies show that repeated episodes of math anxiety activate the fear and pain network in the brain, which overrides thoughtful contemplation, and cause changes in the brain's circuitry. The repeated, self-critical chatter of math anxiety slows, and may stop the processing of mathematical thinking. It makes learning math more difficult. Math anxiety can lead people to retreat into unnecessary limitations imposed by a diminished sense of self-worth, which is often compensated by escaping into magical thinking that has little or no relationship to objective reality. Math anxiety is humanity's most prevalent form of psychosis. Psychosis is a condition that affects the way your brain processes information. It causes you to lose touch with reality.

For an individual, for nations and for better futures for all of us, math anxiety is serious. Math anxiety is the most common mental health problem experienced by children. It creates feelings of helplessness, stupidity and hopelessness. It limits education and employment opportunities, thus reducing lifetime income. This increases stress and statistically reduces life expectancy. It also deprives nations and humanity of talent needed to compete and humanity of talent needed to thrive.

Thus, there is a need for a suite of enjoyable multi-sensual, physical tools, and approaches to learning that motivate students to learn the mathematical thinking skills of observation, logic and creativity through meaningful experiences that help make learning mathematics enjoyable and understandable.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Mathematics can broadly be defined as the study of objects and their relationships. Since objects can be anything and relationships can take any form, the potential uses of mathematical thinking have no boundary. Mathematicians creatively build knowledge based on evidence, such as measurement, and on logical ideas that creatively are built on each other. Learning is easier when it makes sense. Analyzing real and thought experiences is an essential process of education.

The present invention, known as Wiz-Math, is an integrated set of math tools that use physical objects to stimulate students mathematical thinking in order to develop knowledge and understanding. These physical objects, known as Wiz-Blox, Wiz-Flip, Wiz-Dice and Wiz-Dek, are platforms for exercising mathematical thinking skills in order to make sense of addition, subtraction, multiplication, division, fractions, geometry, trigonometry, statistics, algebra, calculus, topology, etc. They are designed for students to enjoy using alone, in teams, or as competitors, at home as they play to learn, and in math classes that use observation, logic and creative thinking. The present invention comprises a set of physical learning tools designed to reduce math anxiety and develop three parts of mathematical thinking skills: observation, logic and creativity.

In one aspect, the present invention provides a system for teaching and learning mathematics, the system comprising a plurality of modules including: a first module having a plurality of blocks for assembling into different configurations; a second module having a plurality of sheets of predetermined mathematical equations; a third module having a plurality of dice having numbers and mathematical operation symbols; and a fourth module having a deck of playing cards.

In another aspect, the present invention provides a method of teaching and learning mathematics, the method comprising the steps of: providing a system having a plurality of modules including: a first module having a plurality of blocks for assembling into different configurations, a second module having a plurality of sheets of predetermined mathematical equations, a third module having a plurality of dice having numbers and mathematical operation symbols, and a fourth module having a deck of playing cards; selecting the first module and arranging the blocks into a desired configuration; selecting the second module and referencing a desired predetermined mathematical equation; selecting the third module and engaging the dice to reference a mathematical equation output; and selecting the fourth module and playing a predetermined game using the playing cards.

In yet another aspect, the present invention provides a non-transitory computer readable medium for teaching and learning mathematics, comprising instructions stored thereon, that when executed on a processor performs the steps of: receiving an input from a user for selecting at least one of a plurality of modules, wherein the plurality of modules comprises a first module having a plurality of blocks for assembling into different configurations, a second module having a plurality of sheets of predetermined mathematical equations, a third module having a plurality of dice having numbers and mathematical operation symbols, and a fourth module having a deck of playing cards; executing and displaying the first module, when selected by the user, the plurality of blocks for the user to assemble into a desired configuration; executing and displaying the second module, when selected by the user, a sheet of predetermined mathematical equations queried by the user; executing and displaying the third module, when selected by the user, at least one combination of the plurality of dice; and executing and displaying the fourth module, when selected by the user, at least one game using the playing cards.

### BRIEF DESCRIPTION OF THE DRAWINGS

Other objects, features, advantages and details appear, by way of example only, in the following detailed description of embodiments, the detailed description referring to the drawings in which:

FIG. 1 is an illustration of a 3-dimensional (“3D”) educational puzzle, known as Wiz-Blox, which is a first module of the system for mathematical education of the present invention.

FIGS. 2A-2C illustrate example end puzzle configurations of the educational puzzle of FIG. 1.

FIGS. 3A-3C illustrate answers to the end puzzle configurations of FIGS. 2A-2C.

FIG. 4 illustrates a method of use of the first module.

FIG. 5 illustrates a method of creating a virtual 3D object in the first module.

FIGS. 6 and 7 illustrate a method of purchasing and saving a 3D object in the first module.

FIG. 8 illustrates available options for modifying a 3D object in the first module.

FIG. 9 illustrates the relationship between a user's device and a back-end server of the first module.

FIG. 10 illustrates the user's options when selecting a 3D object in an augmented reality mode of the first module.

FIG. 11 illustrates the user's options when selecting a 3D object in a virtual reality mode in the first module.

FIG. 12 illustrates a method for manipulating objects in the first module.

FIG. 13 illustrates a method for creating a virtual reality environment and the corresponding actions of the game server in the first module.

FIG. 14 illustrates a method of using the 3D blocks in a virtual reality environment and the corresponding actions of the game server in the first module.

FIG. 15 illustrates a method for creating an augmented reality environment and the corresponding actions of the game server in the first module.

FIG. 16 illustrates a method of using the 3D blocks in an augmented reality environment and the corresponding actions of the game server in the first module.

FIG. 17 illustrates how a user's device interacts with a recipient's device through the game server in the first module.

FIGS. 18A-F are illustrations of worksheets for manually creating 3D blocks.

FIGS. 19-21 are depictions of a flip book having mathematical relationships, known as Wiz-Flip, which is a second module of the system for mathematical education of the present invention.

FIG. 22 is an illustration of a dice set, known as Wiz-Dice, which is a third module of the system for mathematical education of the present invention.

FIG. 23 illustrates a deck of cards, known as Wiz-Dek, which is a third module of the system for mathematical education of the present invention.

FIG. 24 illustrates the number combinations for a 55-card deck of Wiz-Dek shown in FIG. 23.

FIG. 25 is an illustration of an online network for system of the present invention.

FIG. 26 is a schematic of a computer-based system implementing the present invention.

### DETAILED DESCRIPTION

The above-described features and advantages, as well as others, will become more readily apparent to those of ordinary skill in the art by reference to the following detailed description and accompanying drawings.

As stated above, the present invention, Wiz-Math, is an integrated set of math tools comprising Wiz-Blox, Wiz-Flip, Wiz-Dice and Wiz-Dek. Each component or module is separately described in more detail below.

### Module 1—Wiz-Blox

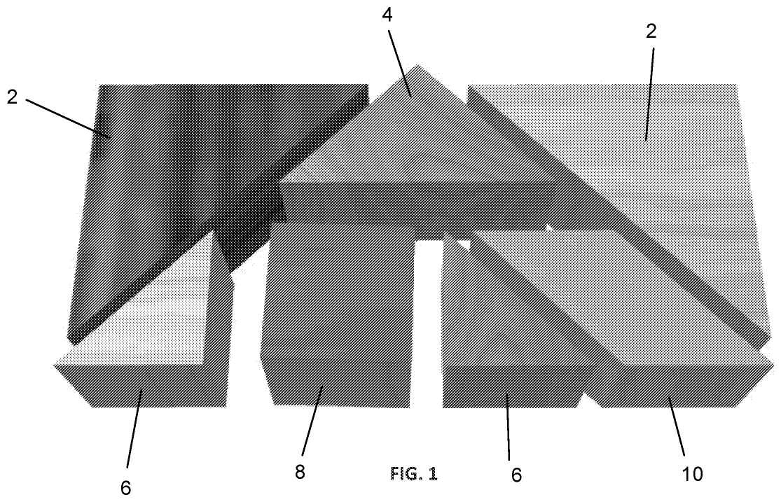

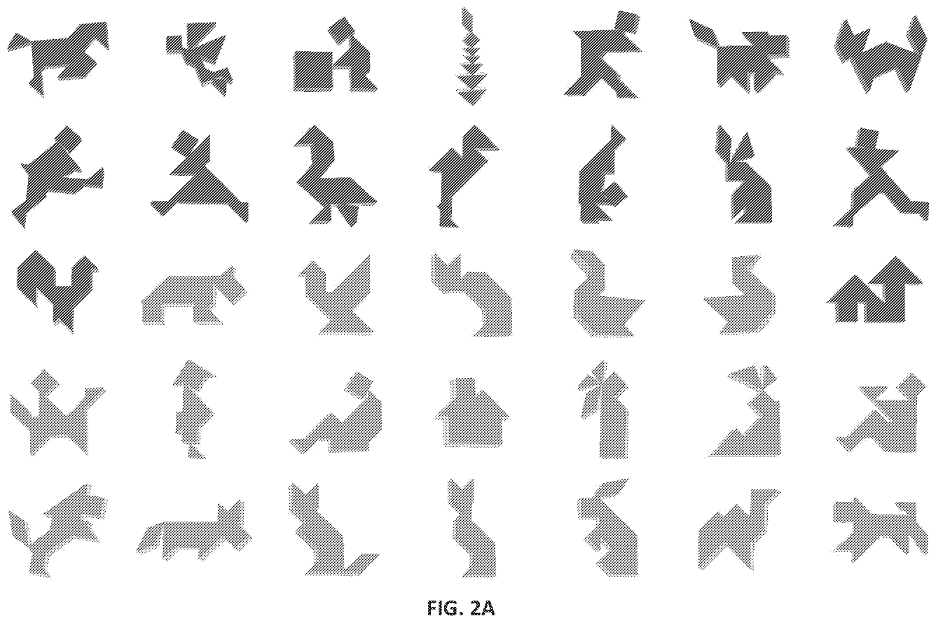

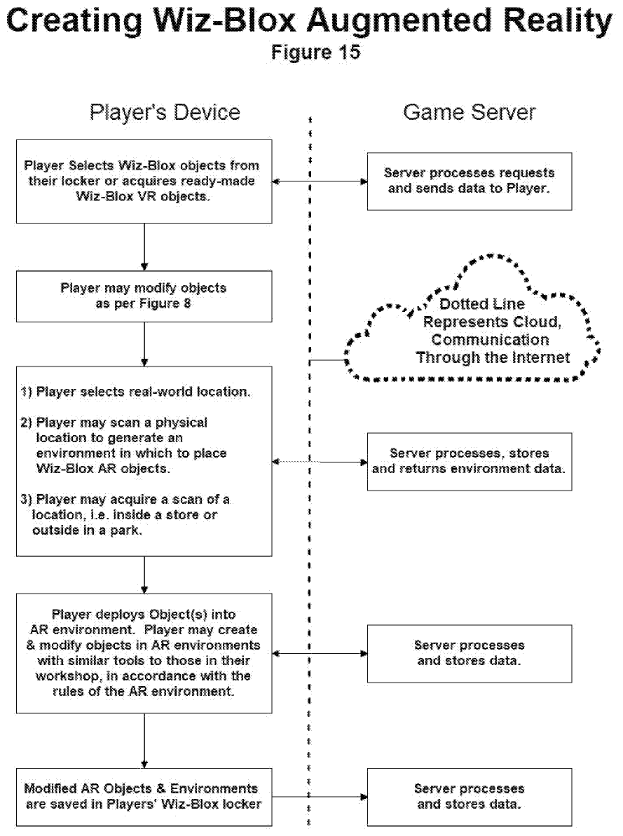

Referring to FIG. 1, Wiz-Blox is comprised of 7 specially shaped blocks, as shown in FIG. 15 of U.S. Pat. No. 4,573,683 to Lamle, titled “Educational Puzzle Cube,” and described therein, which is incorporated by reference. As shown in FIG. 1, in a packaged state, Wiz-Blox is configured such that the 7 blocks form a rectangular block. The blocks may be disassembled into 7 separate blocks of differing geometric shapes. In this embodiment, Wiz-Blox comprises two blocks each having the configuration of a large isosceles right triangular prism 2; one block having the configuration of a medium isosceles right triangular prism 4; two blocks each having the configuration of a small isosceles right triangular prism 6; one block having the configuration of a cube 8; and one block having a configuration of a rhomboid prism 10. The depth of each block 2, 4, 6, 8, 10 is the same such that when the blocks 2, 4, 6, 8, 10 are placed on a flat surface, as shown in FIG. 1, top surfaces of each block 2, 4, 6, 8, 10 are on the same horizontal plane. One of ordinary skill in the art will recognize that the blocks could take on other combinations of shapes and sizes without departing from the spirit and scope of the invention.

Wiz-Blox provides physical and manipulative evidence of numerous mathematical concepts to make the concepts real, tangible and understandable, including: addition, algebra, area, arithmetic, angle, acute angle, obtuse angle, reflex angle, bigger, complementary angle, supplementary angle, congruent, cube, difference, division, deductive reasoning, inductive reasoning, equal, equation, Euler's Law, fraction, geometry, height, hypotenuse, irrational numbers, length, multiple, parallel, parallel lines, parallelogram, parallelepiped, patterns, pentagon, polygon, polyhedron, prime, prism, Pythagorean Theorem, quadrilateral, rational numbers, real numbers, right angle, reflection, rotation, scale, set, shape, similar, smaller, size, sine, cosine, tangent, square, subtraction, symmetry, symmetrical, translations, triangle, right triangle, trigonometry, vertex, volume, and width.

When Wiz-Blox is combined with the other aspects of this invention, students engage in a spectrum of physical and mental activity based on observation, logic and creativity, the foundation of mathematical thinking. Wiz-Blox is a tool for exploring creativity. The 7 specially shaped blocks can be assembled by hand into over 100,000 different 3-dimensional shapes. To encourage creativity, there are 2% rules: (1) Use all seven blocks, or multiple sets of Wiz-Blox; (2) It should not fall down when you remove your hands; and (½) Ignore the first two rules.

Learning to think mathematically by using observation, logic and creativity to build knowledge has immediate intrinsic rewards, and helps develop long-lasting intrinsic rewards. This set of tools designed to shift the motivation for learning mathematics to pass tests, a week short-lived, extrinsic motivator, to you can trim and in and in and learning to think better, which is a long-lived, intrinsic motivator through enjoyable, physical, multisensory experiences.

As part of Wiz-Math, Wiz-Blox has been repurposed into a tool to increase personal creativity, develop grit and mathematical thinking by exploring math concepts in ways that are physical, tangible, meaningful and enjoyable, for children, pre-K to grade 12, and adults. Wiz-Blox is physical, therefore the player uses tactile and kinesthetic as well as visual and aural sensory pathways to play and learn. This creates multiple connections in the brain that form a complexity of understanding and curiosity.

Math is a reliable way to gain knowledge about objects and their relationships. Wiz-Blox are objects in relationships. Wiz-Blox experiences of math concepts are physical, real, immediate and testable. The lessons learned with Wiz-Blox provide the scaffolding of analyzing physical math experiences to better understand math concepts.

In this embodiment, Wiz-Blox is computerized and is played on an electronic device such as a computer or mobile device. Thousands of physical 3-D, puzzles can be built from Wiz-Blox. Although a puzzle may look easy, to solve it may require considerable time and effort, including careful observation, use of logic and flexible creativity. As a puzzle, Wiz-Blox develops players iterative, self-correcting, mathematical thinking skills, with non-judgmental analysis and experimental actions. Wiz-Blox puzzle players repeatedly have internal experience of overcoming the frustrations of failed attempts in order to achieve successes. These experiences tend to develop self-confidence and reinforce the use of careful observation and making logical, creative choices to solve problems.

Wiz-Blox blocks (sometimes referred to as “Blox”) are generated in a 3D computer software modeling program for use in 3D virtual and augmented environments. The user creates a set of 3D Wiz-Blox, using Blender, Maya or any 3D animation/modeling software. The user assembles a variety of 3D Wiz-Blox objects, as puzzles, outline frames, and answers. A selection of these 3D puzzles, using one or more sets of Wiz-Blox, is presented and allows the player to select one for use. As such, Wiz-Blox is a 7-piece math manipulative designed to be enjoyed as art by creatively building three-dimension shapes and structures.

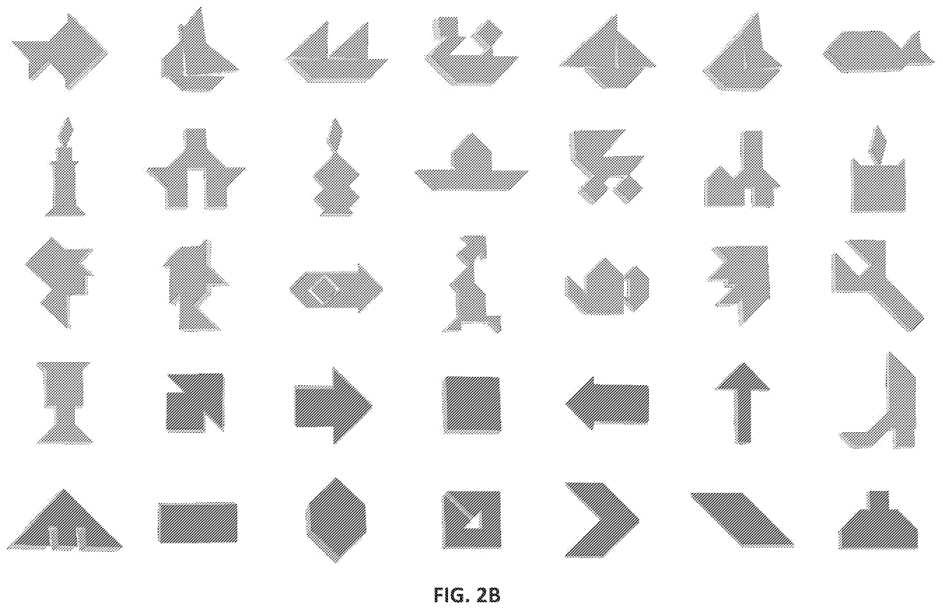

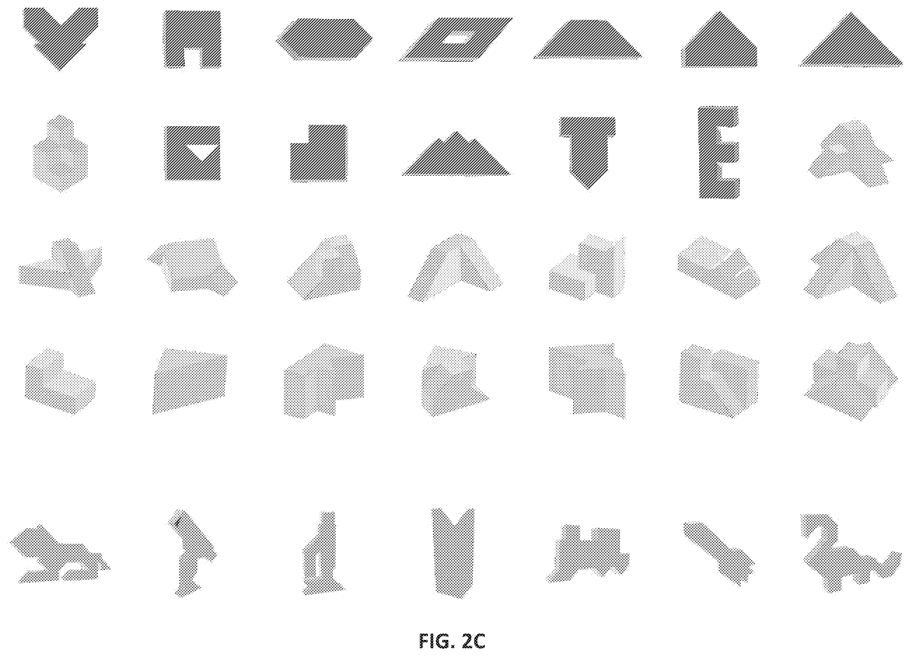

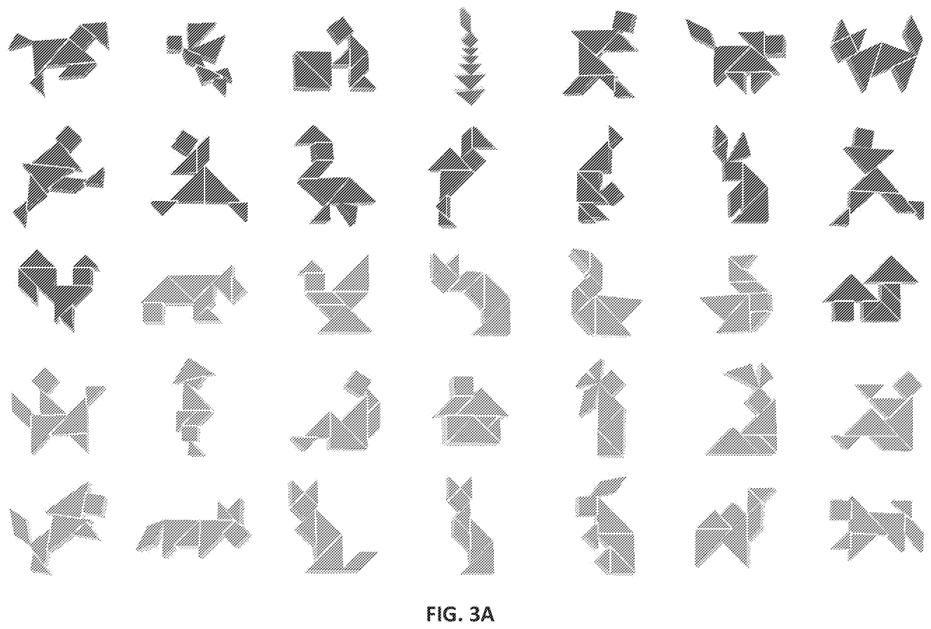

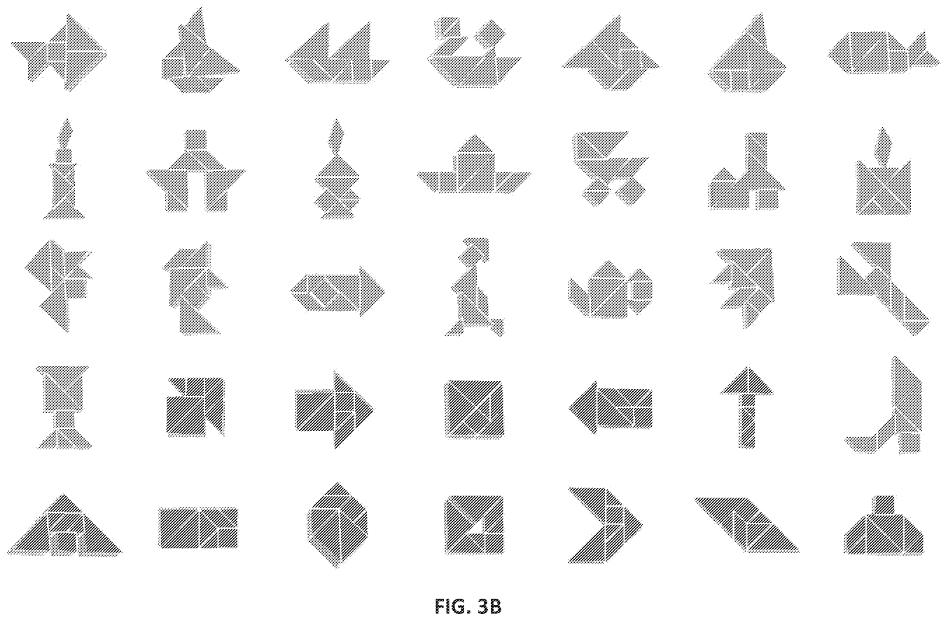

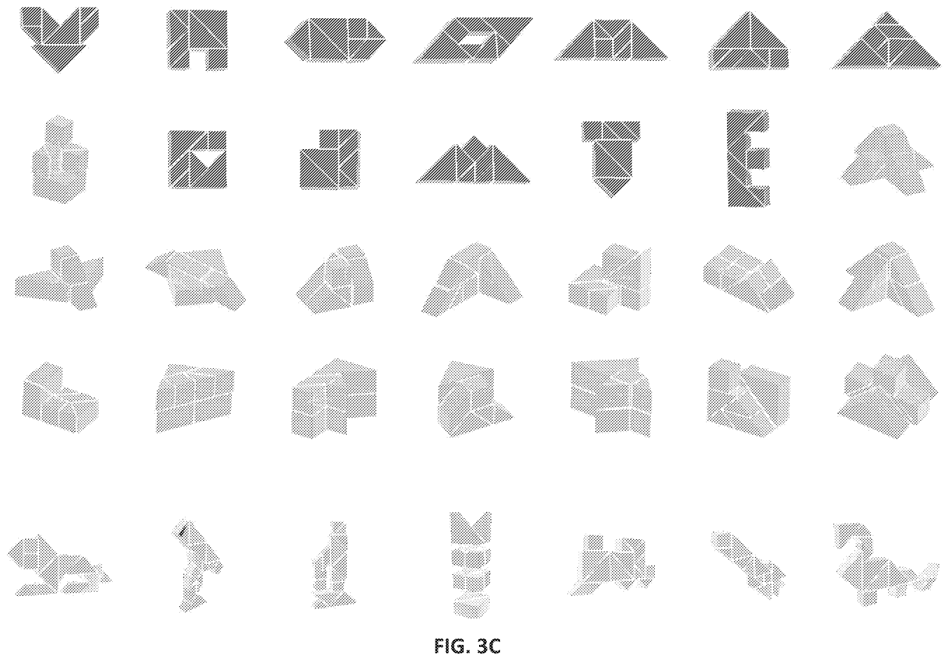

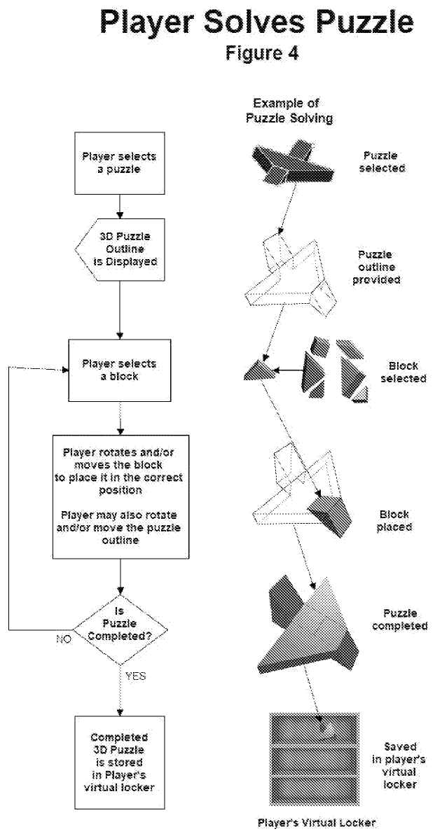

In one aspect, Wiz-Blox is used as a puzzle with thousands of answers. Example puzzles are shown in FIGS. 2A-2C and corresponding answers are shown in FIGS. 3A-3C. Referring to FIG. 4, for solving puzzles, the player or user performs the following steps in his electronic device: (i) the player opens app and a range of puzzles are displayed; (ii) then player selects a puzzle and the outline of the puzzle is displayed; (iii) the player selects a block and may rotate it and move it into a desired 3D position (iv) after the player selects each block, the player positions each of them until the puzzle is complete; (v) the application detects the successful completion of the puzzle and notifies the player of success; and (vi) the player may save his completed puzzle in their virtual locker.

As shown in FIG. 4, steps (i) and (ii), a puzzle is selected and a 3D “outline” of the puzzle zooms into the main viewing area, which shows only the borders of the puzzle.

As shown in FIG. 4, steps (iii) and (iv), the player is challenged to move the blocks into the correct position in the outline to complete the puzzle. The 7 Wiz-Blox shapes are displayed, allowing the player to select them by clicking on them. Once a shape is selected, it can be moved and rotated until it is positioned where the player desires it. The puzzle outline is porous, so that the Wiz-Blox objects can move through the puzzle at will. Blocks may be moved in a variety of ways. The preferred embodiment is to use a camera to detect the player's hands and create virtual copies of them in the computer virtual space. Then, the virtual hands can be used to grab the blocks, then rotate and move the blocks into position. When blocks are positioned closely, within a threshold distance, the program will snap the blocks into exact positions. The threshold can be adjusted so that the snapping will occur at closer or further positions. The virtual space may be rotated, or just the puzzle outline may be rotated, so that the player can view the puzzle and blocks from any angle. The player has an option to see the completed puzzle, i.e., the outline, with all block edges, so that the relationships between the blocks is fully disclosed.

As shown in FIG. 4, step (v), when a player completes a puzzle, celebratory graphics and/or sounds will be displayed. Then, as shown in FIG. 4, step (vi), the player may store their creation or solved puzzles (“structures”) in a virtual locker by means of the storing the position and rotation of each Blox.

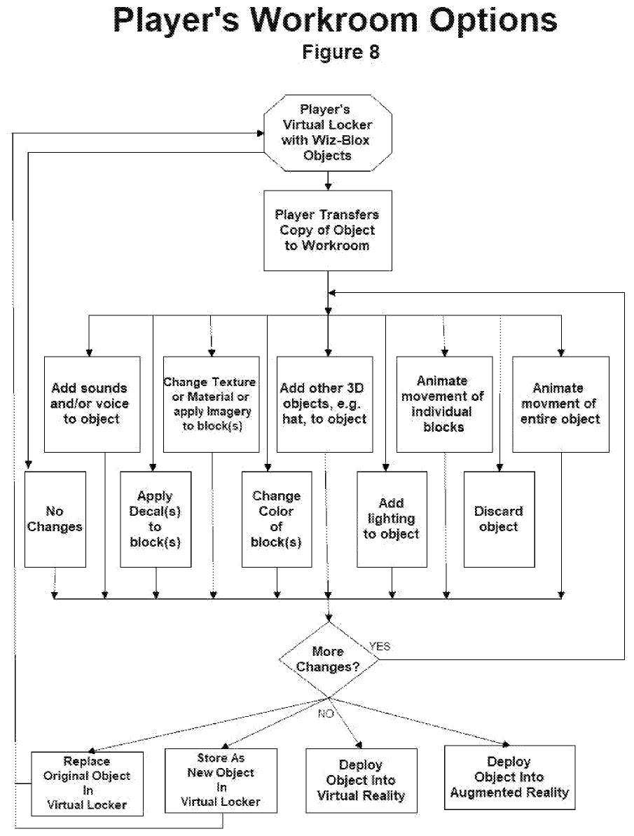

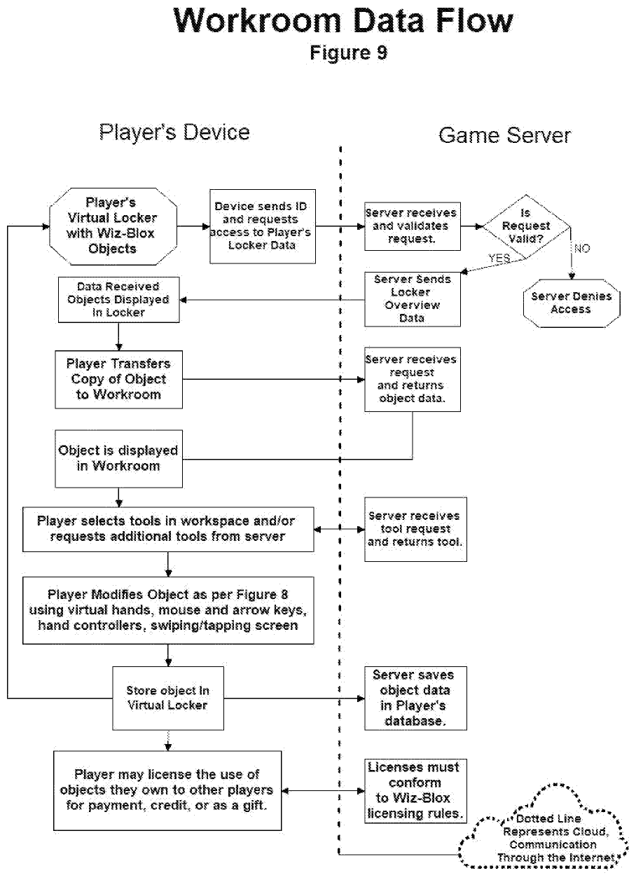

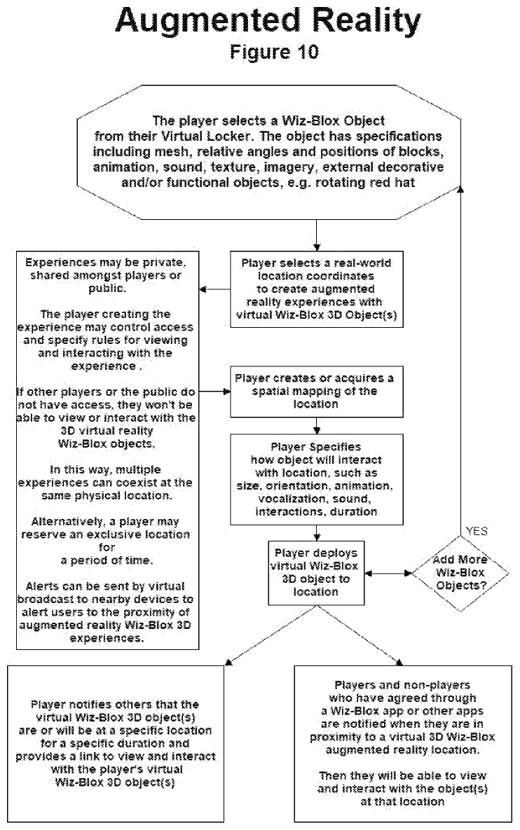

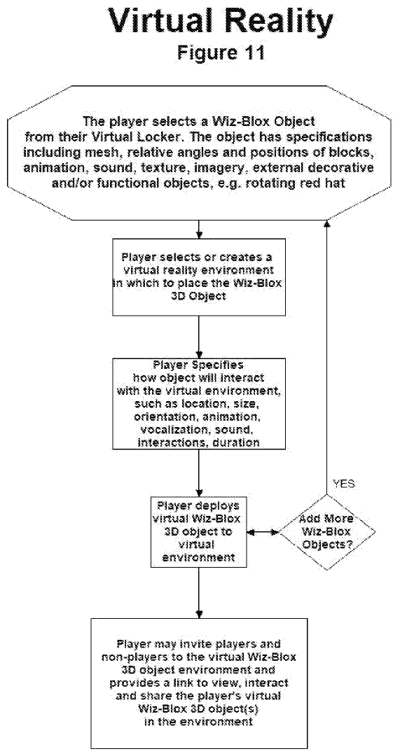

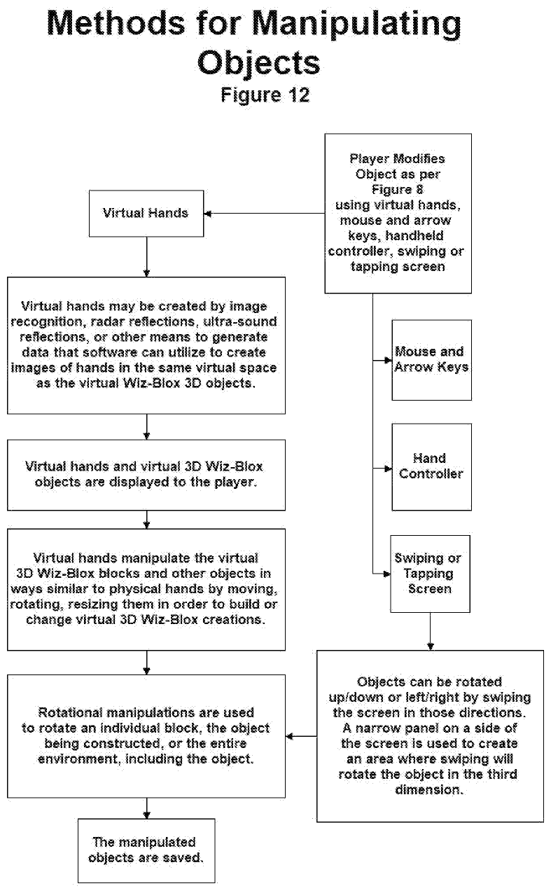

A player will have the ability to decorate and adorn the Wiz-Blox structures by applying color texture and other surface treatments, including decals, to the creation with animation, sound, voice, text and other information save it in the player's virtual locker, as shown in FIG. 8 and described in more detail below. Players may save multiple versions of their structures in their virtual locker for use in virtual and augmented realities.

Moreover, multiple virtual environments are provided in which the player may upload their structures from their virtual locker and place them in a virtual environment, as shown in FIGS. 10-17 and described in more detail below. The environments may be personal or shared. Again, as mentioned above, the player may adjust the size of the structure, the texture, the lighting, the color, add animation, virtual decals, sound, voice, text, messages, and other information into the virtual environment. The players may use this to tell stories, engage in explorations, combat, or play virtual games.

As another feature of the present invention, a player may insert their creations into augmented reality, by specifying a physical location, a size and an initial orientation, as shown in FIGS. 10 and 15-17, and described in more detail below. Augmented reality (AR) is an interactive experience of a real-world environment where the objects that reside in the real-world are “augmented” by computer-generated perceptual information, sometimes across multiple sensory modalities, including visual, auditory, haptic, somatosensory, and olfactory.

The player may also send a link, in a text, e-mail, app or voice message, that lets the recipient(s) know the location or the Wiz-Blox structure that will be available for viewing through cell phones or augmented-reality lenses or other devices, as shown in FIGS. 10 and 15-17, and described in more detail below. The Wiz-Blox structure may be animated and respond to the recipient, by turning to face the recipient, elicit an action when in proximity of the recipient's device, or other responses. The sender may communicate with the recipient(s) via their device.

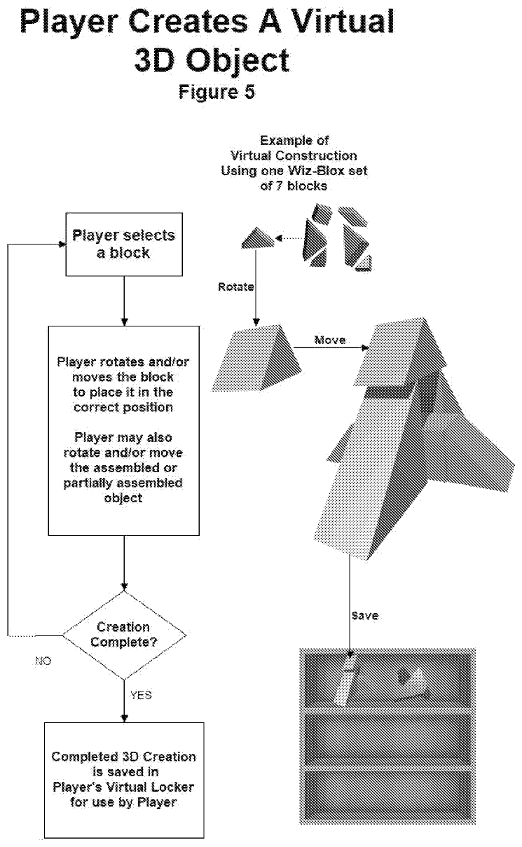

Referring to FIG. 5, the player may also elect to create an object of their own design, thus not selecting any puzzle. For creating a virtual object, the player performs the following steps in his electronic device: (i) player begins with an empty workspace; (ii) player then selects a block and moves and/or rotates it into a desired position; (iii) after, player selects more blocks, possibly using one or more sets, to complete the creation of an object; and (iv) the player may save his creation in their virtual locker when finished.

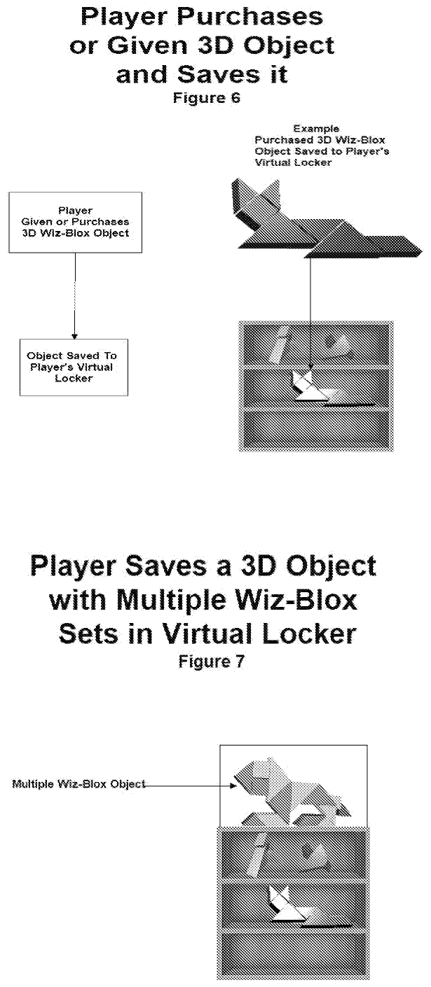

Referring to FIGS. 6 and 7, a player may purchase or be given a 3D object to store in his virtual locker. For example, the player may purchase a completed Wiz-Blox object in a marketplace. The player may also receive a Wiz-Blox object as a gift. Once acquired, the player may save the object in their virtual locker. The player may also purchase—or be given—a Wiz-Blox object made of multiple Wiz-Blox sets. These, too, may be stored in the player's virtual locker.

Referring to FIG. 8, in another aspect of the present invention, as discussed above, the player is provided with various options in the player's workroom, which are controlled electronically. A player accesses their virtual locker and transfers a copy of an object into the workroom space. The player may add sounds, including voices, to the object and control when the audio plays, such as proximity or the touching or tapping of a virtual block, etc. The player may also change the texture or material of any virtual block, adding imagery, if desired. The player may add other 3D objects, such as a virtual hat, to the object. The player may animate the movement of individual blocks and control when the animation occurs, again by proximity to the object or the touching or tapping of a virtual block, etc. The player may animate the movement of the entire object and control when the animation occurs. The player may apply virtual 2D decals to virtual blocks, in the shapes of a mouth, lips, eyes, hat, etc. The player may change the colors of any virtual block. The player may add lighting to the object, possibly animating the lights. The player may discard the virtual object, if desired. Once the player is satisfied with the changes, they may store the virtual object by replacing the original in their virtual locker or creating a new version of the object. Objects may also be deployed into virtual or augmented reality environments.

Referring to FIG. 9, communication between the player's device and the back-end server is shown. The player views their virtual locker through the following steps: (i) player's device sends request for locker information, with player's ID and other information, to the server; (ii) the server validates the ID, if valid, server returns locker overview information; and (iii) the locker is displayed on the player's device. The player selects an individual object for transfer to workroom space through the following steps: (a) the player's device sends request for object's information to server; (b) the server receives request and returns complete information for the selected object; and (c) the object is displayed in the workroom space. A player may use built-in tools or request additional specialty tools from server. The server receives the request and returns the tool. The player modifies the object as per FIG. 8. Once finished, the player stores the modified object in the locker and the server receives all data for the modified object and saves it in the player's database. The player may license their creations to other players, for payment, artist credit or as a gift. The server validates these requests and makes appropriate changes if changes are accepted.

Referring to FIG. 10, the augmented reality aspect of the present invention is shown. The player selects an object from their virtual locker. Object specifications include the relative positions of all blocks and all workshop modifications, including textures, lighting, audio, etc. The player selects a real-world location for their augmented reality display. The location may be an already known spot, or the player may scan a space to map surfaces, etc. into a new augmented reality location. The player deploys Wiz-Blox objects from locker into the AR space, positioning, rotating and sizing them. The player sets up rules about how interactions between players and objects will occur. AR locations may be private, shared among players, or fully public. The player creating the space also defines the rule for access and interaction with the virtual aspects of the location and its objects. Players without access will be unable to see the AR location. This allows multiple players to create AR spaces in the same physical space. Locations may also be reserved exclusively to specified periods of time, e.g., a Wiz-Blox object may be positioned near the meat aisle of a supermarket in connection with a promotion for lamb chops. Wiz-Blox servers will monitor the location of users and alert them when they are proximate to an AR location that they may access. Players may also notify and invite users to their AR creations.

Referring to FIG. 11, the virtual reality aspect of the present invention is shown. A player may create a VR environment or purchase or select a ready-made environment. The player then selects Wiz-Blox objects from their virtual locker. The player then deploys objects into the VR environment, specifying their position, rotation and size within the VR environment. The player may specify how the object will interact with the environment, including sound, animation, etc.—see Workroom options, FIG. 8. The player may add more objects to the VR environment. The player's environment is saved by the Wiz-Blox server. Lastly, the player may invite players and non-players to view and interact with their VR environment, by providing a link.

Referring to FIG. 12, methods for manipulating objects are shown. A player may interact with their Wiz-Blox creations in a variety of modalities and objects are manipulated. Virtual hands may be displayed by a variety of technologies, such as image scanning, radar or sound reflections, or other means. Virtual hands appear to the player and mimic the motions and actions of the player's real hands. Mouse and arrow keys may also be used to manipulate objects. Various hand controllers are available for manipulation. A device's screen may be swiped or tapped for manipulative purposes. In this case, up/down and left/right motions may be performed by swiping in those directions. For the third dimension, a narrow panel on the side of the screen can be swiped to rotate the model about the “z” access. Rotational manipulations are used to rotate an individual block, the object being constructed, or the entire environment, including the object, to assist the players in constructing objects. The manipulated objects are saved in the player's virtual locker by sending data to the Wiz-Blox server.

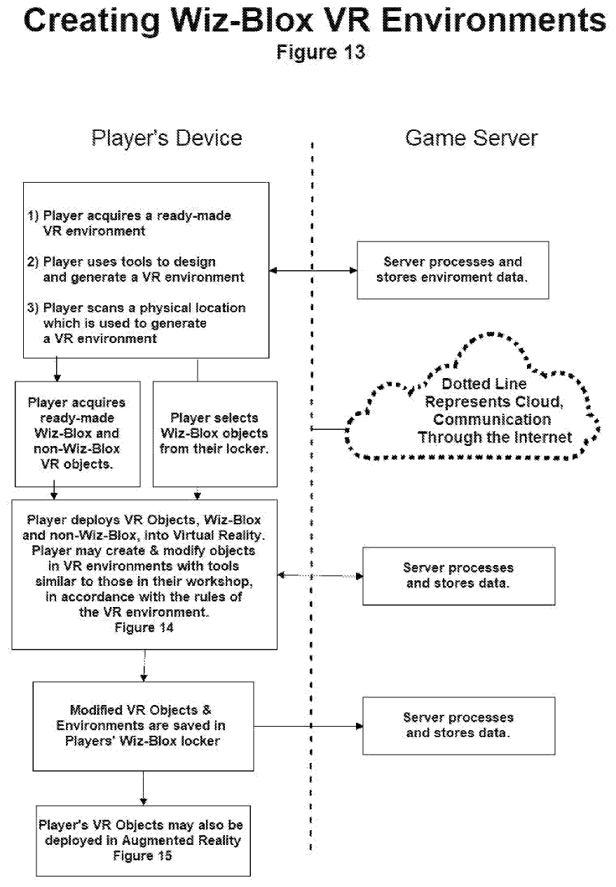

Referring to FIG. 13, a method of creating virtual environments is shown. A player may purchase or select a ready-made VR environment. The player may modify this environment, using conventional 3D modeling tools. The player may create a VR environment, using conventional 3D modeling tools. 3D mapping tools are available to scan a physical location and use the data points to create a 3D virtual model of that location. The server stores the VR environment data and makes it available in the player's virtual locker. A player selects a VR environment. Then a player selects Wiz-Blox objects from their virtual locker or acquires objects from a marketplace or as a gift. The player deploys VR objects into the VR environment, specifying their position, rotation and size within the VR environment. A player may specify how the object will interact with the environment, including sound, animation, etc.—see Workroom options in FIG. 8. The Wiz-Blox server receives, processes, and stores data about VR Environment, VR Wiz-Blox objects and non-Wiz-Blox VR objects. The VR Wiz-Blox objects may also be deployed into AR environments.

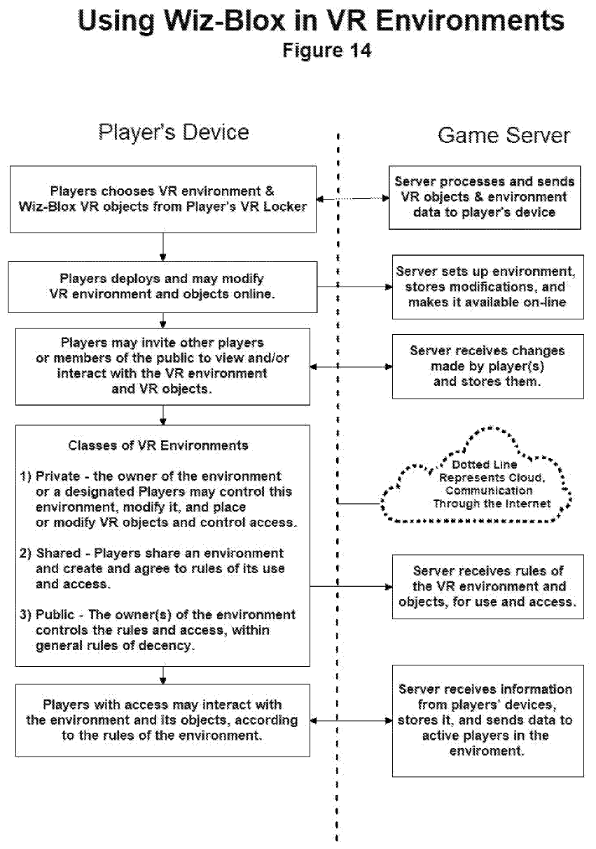

Referring to FIG. 14, a method of using Wiz-Blox in virtual environments is shown. Players chooses VR environment and Wiz-Blox objects from player's VR locker. The server processes and sends VR objects and environment to player's device. A player deploys Wiz-Blox 3D VR objects the VR environment and posts it online. The server sets up environment, stores modification, and makes it available on-line. While on-line, players may modify the VR environment and objects. The server receives modifications and makes them available on-line. A player may invite other players—or members of the public—to view and/or interact with VR environment and VR objects. The server then processes these requests and sends invites to the invited recipients. There are also different classes of VR environments players may enter into. Environments may be private, owned and controlled by a single player. Environments may be shared among players, who create and agree to rules of its use and access, e.g., players may or may not be allowed to move or change other player's objects. Environments may be fully public, open to everyone. The owner(s) of the environment controls the rules and access, within general rules of decency. The server receives rules of the VR environment, stores them for use and access. When players interact with an environment, the server communicates with players active in that environment, in order to inform them of the motions and actions of the other players.

Referring to FIG. 15, a method of creating augmented realities is shown. The player selects Wiz-Blox objects from their virtual locker or acquires objects from a marketplace or as a gift. A player may modify objects as per FIG. 8. The player may select—real-world location coordinates and related information. The player may select 3D mapping tools to scan a physical location and map floors, walls, surfaces, etc. The data points are used to create an AR virtual model of that location. The server stores the AR environment data or coordinates and related information in the player's virtual locker. A player deploys VR objects into the AR environment, specifying their position, rotation and size within the AR environment. The player may specify how the object will interact with the environment, including sound, animation, etc.—see Workroom options in FIG. 8. The player may add more objects to environment, as desired. Wiz-Blox server receives, processes, and stores data about VR Environment, VR Wiz-Blox objects and non-Wiz-Blox VR objects.

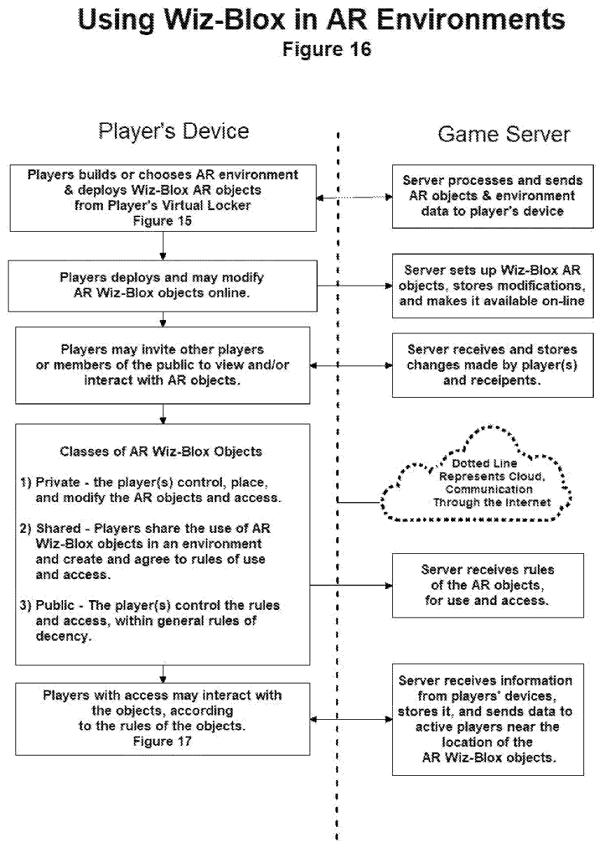

Referring to FIG. 16, a method of using Wiz-Blox in augmented reality is shown. The player builds or chooses an AR environment and deploys Wiz-Blox virtual objects into it, as per FIG. 15. The same virtual Wiz-Blox objects data are available for use as VR Wiz-Blox objects and AR Wiz-Blox objects. The server receives data about the environment and saves it. The player deploys Wiz-Blox 3D AR objects into the AR environment, with optional start time and duration, and posts it online. The server sets up the Wiz-Blox AR objects, stores modifications, and makes them available on-line. Wiz-Blox AR objects may be private, owned and controlled by a single player. Wiz-Blox AR objects may be shared among users, who create and agree upon the rules of use and access, e.g., players may or may not be allowed to move or change other player's objects. Wiz-Blox AR objects may be fully public, open to everyone. The player(s) controls the rules and access, within general rules of decency, e.g., no profanity or personal insults. The server then receives the rules and stores them for use and access. The server receives information from players' devices, stores, processes, and sends data to active players near the location of the AR Wiz-Blox objects.

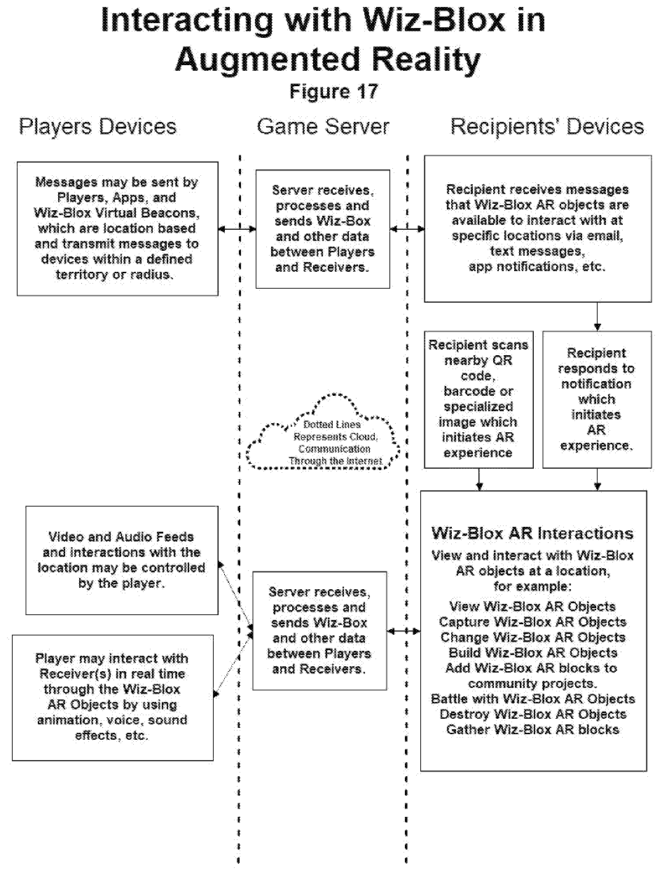

FIG. 17 shows a method of interacting with Wiz-Blox with augmented reality. Messages and data are sent between player(s) and receivers travel through the Wiz-Blox server. Messages may be sent by Players, Apps, and Wiz-Blox Virtual Beacons, which are location based and transmit messages to devices within a defined territory or radius. Communication devices may be in the form of cell phones, smart phones, tablets, computers, wearable technology and the like. The Wiz-Blox server notes the locations of players and environments and notifies devices of receivers when they are near a location with Wiz-Blox AR objects that they may interact with. The server receives data and sends updates to players and members of the public near a location with Wiz-Blox AR objects. Recipients may respond to a notification or scan a nearby QR code, barcode or specialized image to initiate the AR experience. Receivers may interact with Wiz-Blox objects in real time through their devices. The Wiz-Blox server updates the status of the Wiz-Blox objects and player's interactions. Players may deploy the Wiz-Blox VR 3D objects and may use them to interact with members of the public or players with access, through their devices, by using animation, voice or other means. Video and audio feeds and interactions with the location may be controlled by the player. Members of the public or players with access may interact with Wiz-Blox objects in many ways, e.g., viewing, capturing, changing, building, battling, destroying or gathering blocks or objects, or other creative ways. Player may invite other players, or members of the public, to view and/or interact with the Wiz-Blox AR objects. The server processes these requests and sends invites to the invited recipients. With publicly viewable objects, server will alert cell phones, tablets, and other related devices in proximity to the environment in which the VR objects are placed. When members of the public interact with an environment, the server communicates with cell phones, tablets, and other related devices of members of the public in proximity to the location of the objects. With non-publicly viewable objects, server will alert cell phones, tablets, and other related devices of players with access in proximity to the environment in which the VR objects are placed. When players interact with an environment, the server communicates with cell phones, tablets, and other related devices of members of the public in proximity to the location of the objects.

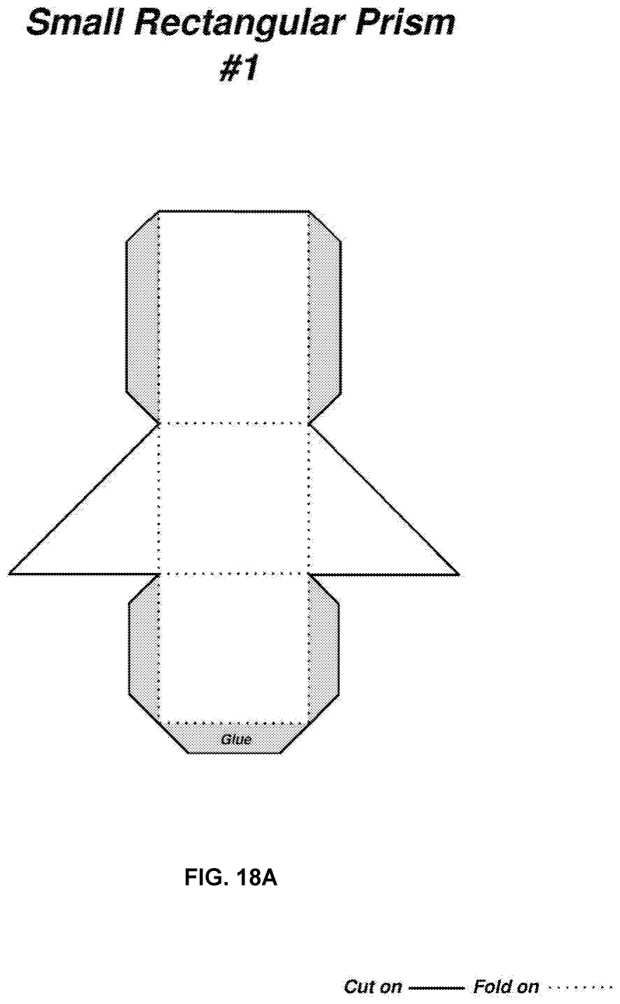

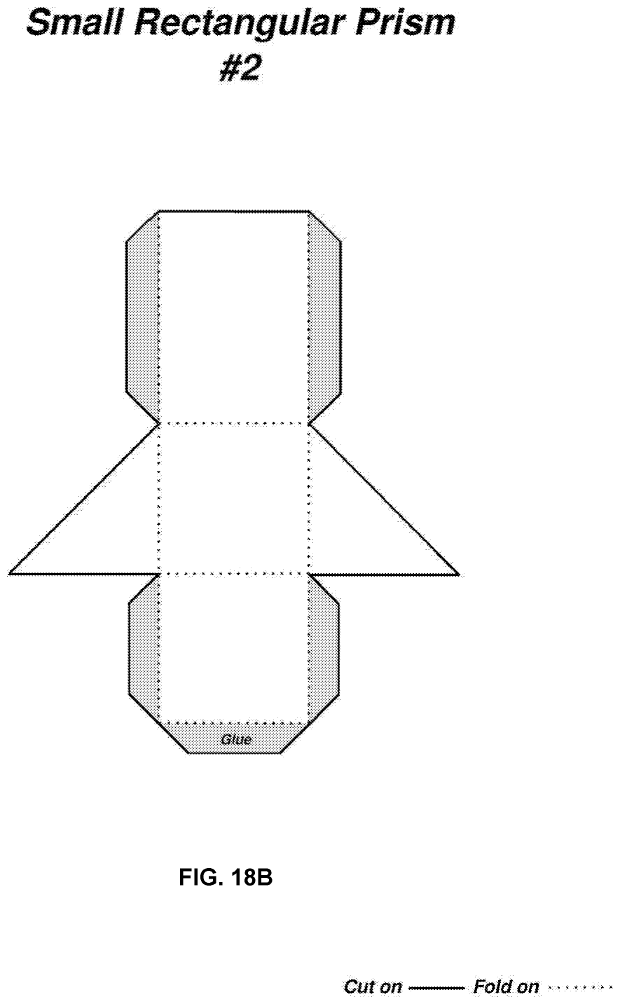

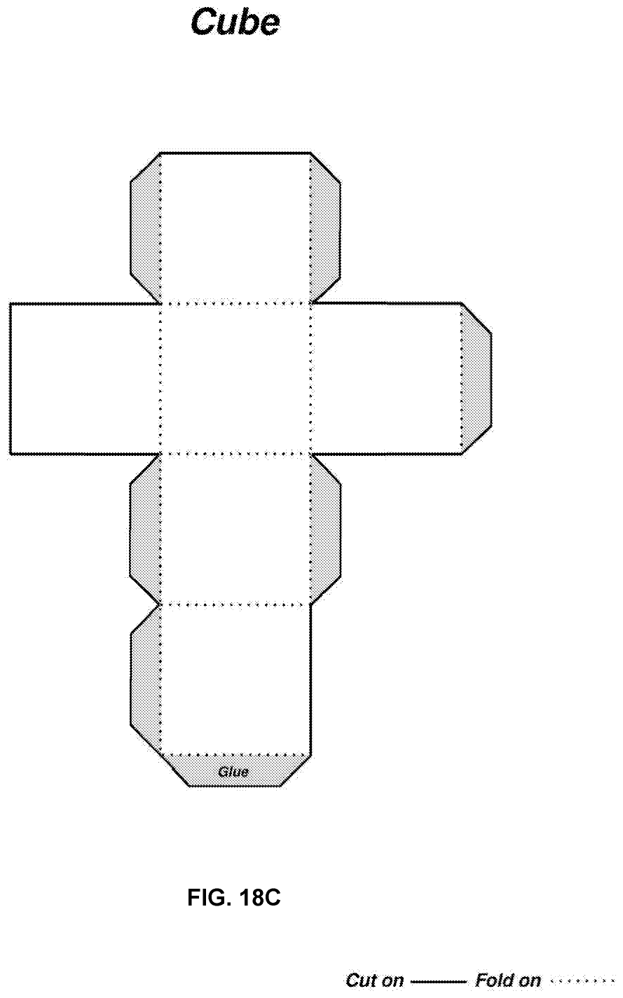

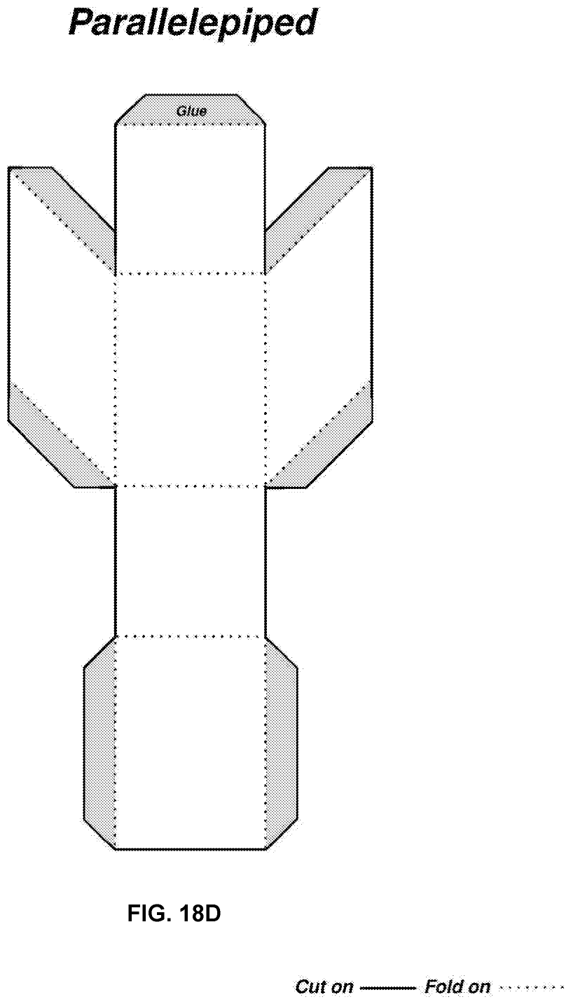

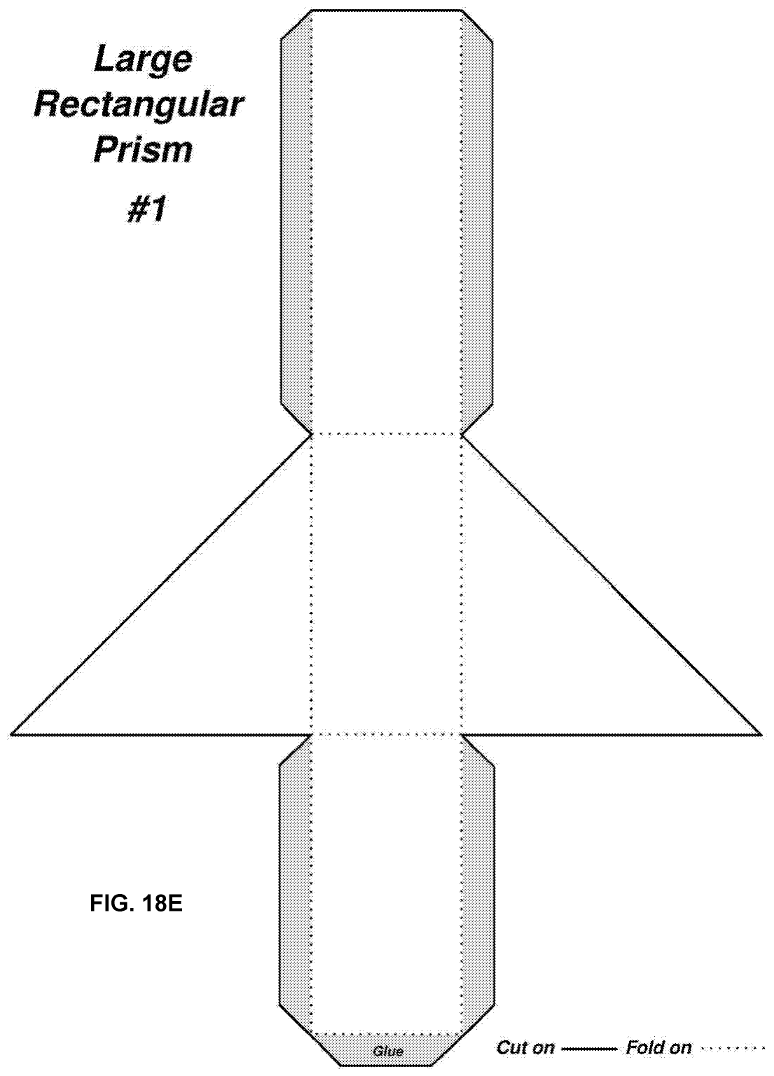

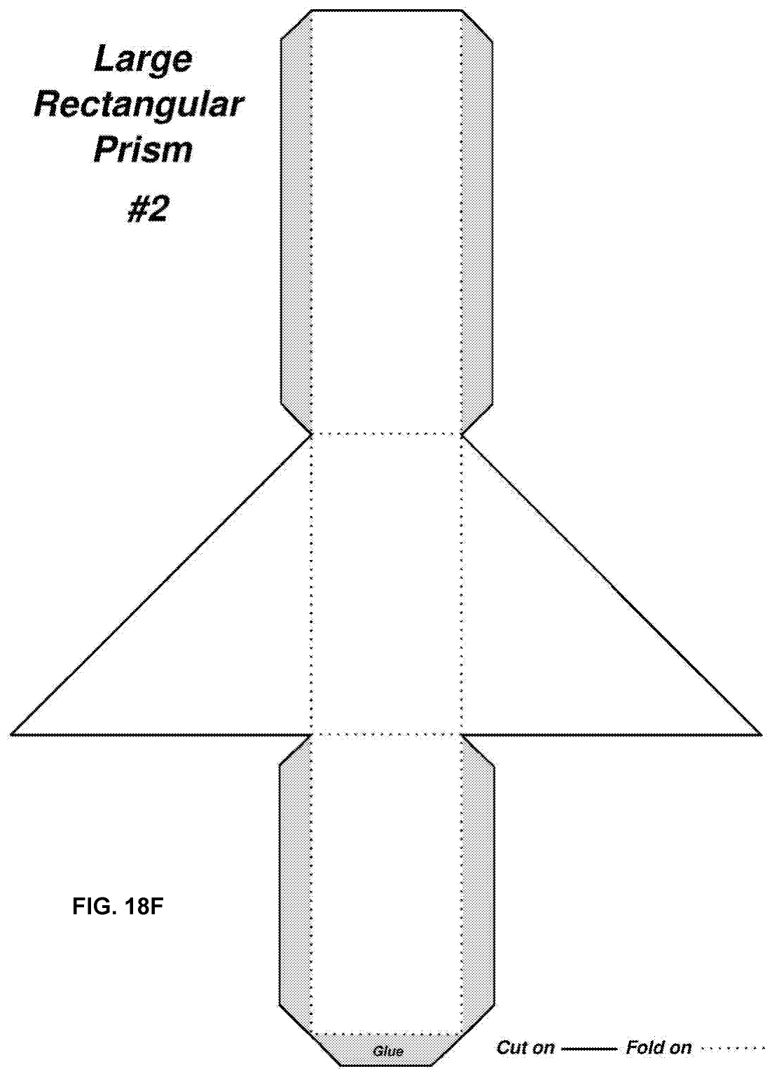

In an alternative embodiment, Wiz-Blox could be manufactured and sold as a physical unit, as shown, for example, in FIGS. 18A-F, which are worksheets with assembly instructions. Each unit could vary in size, for example, having lengths and widths of 35 mm, 50 mm and 6 inches, and shapes, for example, a small rectangular prism, a cube, a parallelepiped and a large rectangular prism. Each unit is provided with solid lines indicating where the user should cut the paper, dotted lines indicating where the user should fold the paper in order to create hinges, and shaded portions indicating where the user should apply glue to form the block. The overall area of each unfolded block could range in size equaling, for example, 35 mm², 50 mm² and 60 in².

In other embodiments, physical decals in various packets for customized creative projects could be provided, for example, cartoons and other images such as eyes, mouths, nostrils, ears, feet, hands, hair, brick, stone, grass, polka dots, mirror, color, etc.

In other embodiments, a smartphone app could be provided for online sublistatic full-color printing of full-size, fully detailed customizable decals for users who want to give individuality and personality with their custom decaled, Wiz-Blox creations memorialized for future enjoyment.

### Module 2—Wiz-Flip

Addition, subtraction, multiplication and division tables, also known as arithmetic tables, have long been used to teach students basic arithmetic facts, such as 2+2=4, and flashcards have been used to aid memory. Unfortunately, many individuals find the arithmetic tables, and flashcards to be confusing, intimidating and anxiety provoking. Therefore, many students put them to minimal use. Teaching multiplication with conventional means can be a slow and tedious process that can create anger, internalized or expressed, and a feeling of self-diagnosed incompetence in students, which can lead to lifelong math anxiety that has a debilitating effect on the lives and opportunities of billions of people.

A need, therefore, exists for devices that makes learning to add, subtract, multiply and divide convenient and fun by finding ways to make connections, create meaning or otherwise understand the rules governing arithmetic, in order to accelerate understanding numerical relationships and to build arithmetic skills with frequent, short, enjoyable observations and reviews that stimulate thought and memory.

We have known that experience is the best teacher for many millennia. Confucius, Aristotle, Caesar, Einstein, and many others express this fundamental idea. Hands-on experiences with the opportunity to make discoveries creates information in multiple parts of the brain through processing multisensory, thoughtful experiences.

In light of the problems associated with conventional, arithmetic tables, and flashcards, it is a principal object of the invention, to provide an arithmetic teaching device that permits a user to access relationships of addition and subtraction as well as, or in addition to, multiplication and division with convenient, multisensory experiences of looking up relationships, which can improve learning by involving multiple parts of the brain.

It is another object of the invention to provide an arithmetic teaching device of the type described that is self-contained and requires neither additional tools nor prolonged training to operate effectively.

It is a further object of the invention to provide an arithmetic teaching device of the type described that permits a user to quickly solve many types of arithmetic problems. For example, the device can be used to find: the products of any two numbers from 1 to N, and the greatest common factor of the two numbers.

It is an object of the invention to provide improved elements and arrangements thereof in an arithmetic teaching device for the purposes described which is uncomplicated in construction, inexpensive to manufacture, and easy to use.

The present Wiz-Flip invention relates generally to devices for the purposes of mathematics education and specifically the demonstration of relationships between multiplication and division as well as squares of numbers, and whole number square roots, in a flipbook format designed to invite repeated, multisensory investigation of relationships and patterns that students may observe, or create while flipping through the flipbook, which shows how a single number in the range of 1 to n can be multiplied by each of the numbers from 1 to n to derive the answer.

The present Wiz-Flip invention also relates to the demonstration of relationships between addition and subtraction as well as squares of numbers in a flipbook format designed to invite repeated, multisensory investigation of relationships and patterns that students may observe, or create while flipping through the flipbook that shows how a number in the range of 1 to N can be added to each of the numbers from 1 to N to derive answers.

Many students try to learn the multiplication table by memorizing separate math facts, such as 7×8=56, and 6×9=54. However, memorizing the multiplication table can feel overwhelming, arduous, tedious and time consuming for young children.

Flash cards are frequently used to aid learning math facts such as 8+2=4. However, for many students, flash cards experienced as mini tests that provoke anxiety when students do not know the answer, which can make learning difficult.

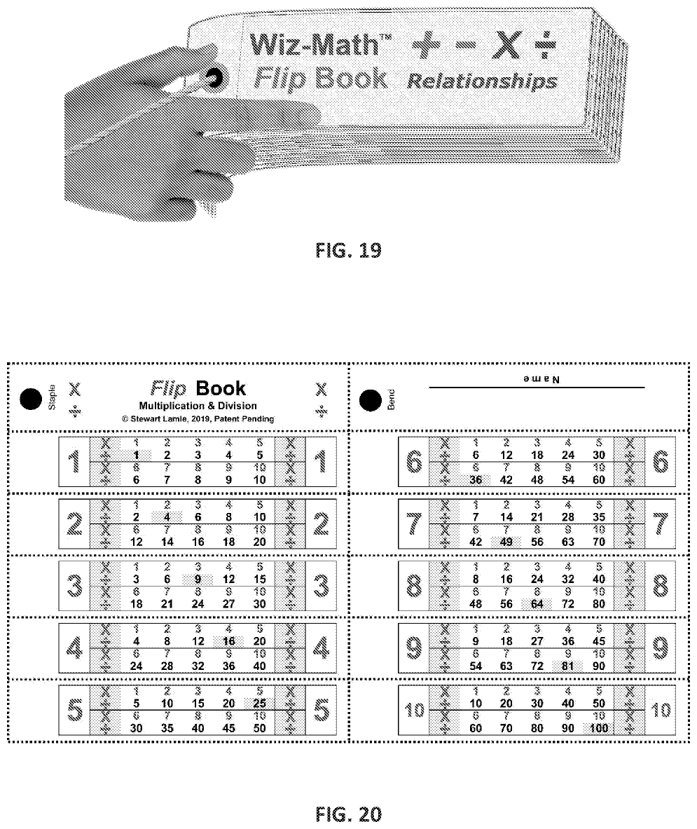

FIG. 19 shows Wiz-Flip, the second module in Wiz-Math, which is a flip book that shows the relationships of each number from 1 to 10 in a physical embodiment. The physical embodiment may be worn on a wrist strap, as shown below for easy flipping to look up and understand the relationships of numbers. Wiz-Flip can also be in the form of a computer program, either stand-alone or as part of a module, as is here with respect to Wiz-Math.

In one embodiment, as shown in FIG. 20, a sheet having multiplication and division relationship tables are provided. The sheet includes principal numbers from 1 to 10, in 10 strips that are multiplied by the numbers 1 to 10. As such, the user is able to quickly reference a product of two numbers multiplied. For example, if the user wishes to find the answer to the math problem, 3 multiplied by 3, the user refers to the strip having the number “3,” then searches the red number “3” in the “X” row, and finds the answer in black below the red number “3,” i.e., “9.”

The 10 strips also include numbers of multiples of 1 through 10 for each of the principal numbers. As such, the user is able to quickly reference a quotient resulting from dividing a multiple by a principal number. For example, if the user wishes to find the answer to the math problem 60 divided by 6, the user refers to the strip having the number “6,” searches for the black number “60” in the “÷” row, and finds the red number “10” above the black number “60.”

Alternatively, there can be more than 10 principal numbers, e.g., 12 principal numbers, one on each of 12 strips that are multiplied by more than 10 different number, e.g., 15 different numbers, to help students learn the 12×15 times and division table, or any combination of principle numbers and numbers that are multiplied by them to form answers.

In another embodiment, as shown in FIG. 21, a sheet having addition and subtraction relationship tables are provided. The sheet includes principal numbers from 1 to 10, in 10 strips that are added by the numbers 1 to 10. As such, the user is able to quickly reference a sum of two numbers added. For example, if the user wishes to find the answer to the math problem, 3 added to 3, the user refers to the strip having the number “3,” then searches the blue number “3” in the “+” row, and finds the answer in black below the red number “3,” i.e., “6.”

The 10 strips also include sums of all combinations of principal numbers 1 through 10. As such, the user is able to quickly reference a difference resulting from subtraction of a principal number from a sum. For example, if the user wishes to find the answer to the math problem 20 minus 10, the user refers to the strip having the number “10,” searches for the black number “20” in the “−” row, and finds the blue number “10” above the black number “20.”

Alternatively, there can be more than 10 principal numbers, e.g., 12 principal numbers, one on each of 12 strips that are added with more than 10 different number, e.g., 15 different numbers, to help students learn the addition and subtraction of an expanded combination of numbers.

In the embodiments described above, each sheet is constructed of a durable paper material to withstand wear and tear. The strips are divided with dotted lines so that the user is able to cut along the lines and form evenly sized strips in the event that the user wishes to form a flip book as shown above. Alternatively, holes could be pre-cut into the sheets for coupling each strip together with a wrist strap, as shown in FIG. 19.

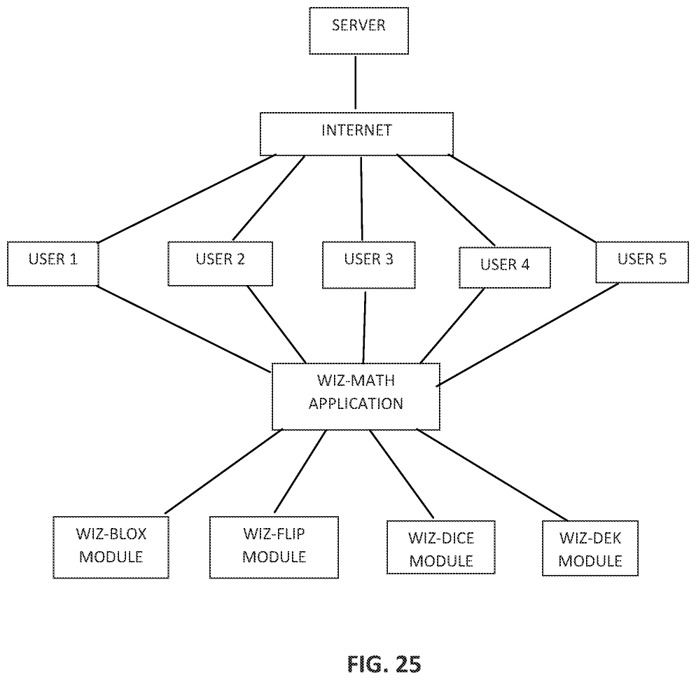

As described above, Wiz-Flip can also be in the form of a computer program, either stand-alone or as part of a module, as is here with respect to Wiz-Math. As shown in FIG. 25, when a user is logged into Wiz-Math, the user selects Wiz-Flip to access the sheets shown in FIGS. 20 and 21. The user can either input specific math problems, which will then direct the user to the corresponding sheet, or simply search for the relevant sheet, which is displayed in digital format.

Students using the Wiz-Flip to look up relationships and check their calculations are engaging in purposeful, repeated physical activity and mental involvement that use multiple pathways to learn patterns and relationships, which create understanding and memory with reduced math anxiety.

### Module 3—Wiz-Dice

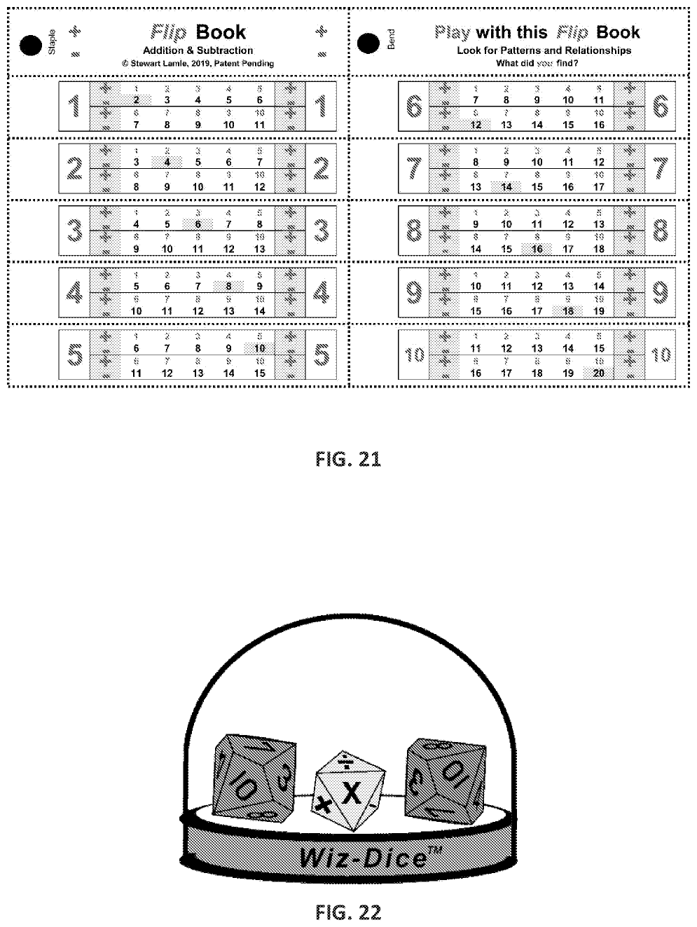

FIG. 22 shows Wiz-Dice, the third module of Wiz-Math. In one embodiment, provided are three dice, two 10-sided dice with equal areas on each face, in different colors, i.e., one red and one, and one blue and one white 8-sided die, with equal areas on each face. The sections of the 10-sided dice are numbered 1 through 10, or alternately 0 to 9. Two of the opposite surfaces of the 8-sided die are marked with a plus sign (+), two other opposite surfaces are marked with a minus sign (−), and two of the opposite surfaces of the 8-sided dice are marked with a times sign (×) and the other two opposite surfaces are marked with a division sign (÷).

In operation, the user of student shakes the dice and records the numbers and arithmetic operation of the third die in the order of colors to determine the result. The student creates the math questions by shaking the dice in the dome. The results, which are random, are the combination of the top bases of each die. Math lessons can explore issues of randomness and biases.

As an example, the results can be displayed both as the order of operation, Red, White and Blue equals the answer, and as Blue, White and Red equals the answer, as shown below.

| Red, White and Blue: | Blue, White and Red: |
|---|---|
| 7 + 8 = 15 | 8 + 7 = 15 |
| 8 − 7 = 1 | 7 − 8 = −1 |
| 8 × 7 = 56 | 7 × 8 = 56 |
| 8 ÷ 7 = 1 1/7 | 7 ÷ 8 = ⅞ |

Alternatively, for more advanced calculation, the dome may contain five dice, for example: a smaller, and a larger red, 10-sided dice, a die with the operators: +, −, ×, ÷, and a smaller, and a larger blue, 10-sided dice. For less advanced calculation the 4-sided die, or 8-sided die with the operators may have only two different operators for example: +, −, or ×, ÷.

Wiz-Dice can also be in the form of a computer program, either stand-alone or as part of a module, as is here with respect to Wiz-Math. As shown in FIG. 25, when a user is logged into Wiz-Math, the user selects Wiz-Dice to access the module. The user makes selections to set parameters as described above. The user then selects a button to roll the dice shown in FIG. 22, which is displayed in digital format. The result of the roll is then displayed in digital format.

### Module 4—Wiz-Dek

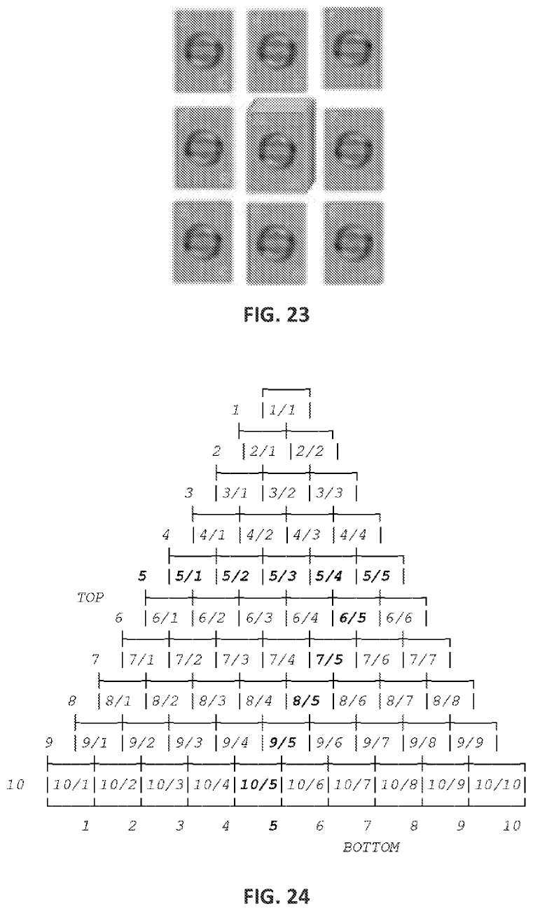

FIG. 23 illustrates Wiz-Dek, the fourth module of Wiz-Math. Wiz-Dek is a deck of playing cards having numbers on both sides of each playing card for playing games relating to mathematics. Wiz-Dek promotes practice, teamwork and competition.

As shown in FIG. 24, a preferred Wiz-Dek with 10 different numbers has 55 unique 2-sided playing cards with a number from 1 to 10 on each side of the cards, combinations of which are shown in therein. Alternatively, a deck with 11 different numbers has 66 unique 2-sided playing cards with a number from 1 to 11 on each side of the cards can be provided. The 11th index may also be a Joker. In a further alternative, a deck with 12 different indices has 78 unique 2-sided playing cards with an index on each side of the cards can be provided.

Each card in the game set or deck displays an indicia combination which is unique in the set, and the total number of pieces in the set is equal to (N)(N+1)/2, as described in U.S. Pat. No. 4,570,940 to Lamle, which is incorporated by reference. One of the most useful such decks has 10 different indices. Thus, in the embodiment shown in FIG. 24, the total number of cards is 10×11/2=55. Alternatively, the deck could include other 2-sided card combinations having the following relationship of index to cards: N squared=cards, as described in U.S. Pat. No. 4,998,737 to Lamle, which is incorporated by reference.

Some examples of games using Wiz-Dek are described below. These examples are not exhaustive, as shown in Appendix 1 of U.S. Provisional Application No. 63/192,294, to which the present application claims priority and is incorporated by reference.

In one example, a game called KOMBO is played with Wiz-Dek to promote concentration.

The game involves 2 to 4 players and instructions for the game are as follows:
Object—Turn a card over. If the new face matches any of the top faces (except the top face of the deck) collect the matching cards. The player with the most cards wins!
Layout—Deal 3 rows of cards: The first row has three cards. The middle row has one card, a space for the remainder pack and another card. The third row has three cards. Place the pack in the center. See FIG. 23.
Play—The player turns over 1 card in the layout, but not the top card of the remainder pack in the center. If the new face is a MATCH with any of the top faces of the other cards (not the remainder pack), all the cards with a matching face are collected and placed, matching face up, on the players stack.
Steal—A player who makes a match which also matches the top face of an opponent's stack takes the opponent's whole stack!
Deal—The player who made the match deals new cards from the pack to the layout. (Do NOT turn cards over). Winners go again until the player does NOT make a match. Winning players continue to try to make matches by turning over one card in layout, collecting cards and refilling the layout. When a card is turned over that does not match, the card remains with the new face up and the next player plays.
Note—The final cards, if they don't match, go to the player who made the last match.
Win—The player with the most cards is the BIG Winner! Players who have any cards in their stack are Winners!

In another example, a game called NUMBER HUNTER is played with Wiz-Dek to promote creativity. The game involves 1 to 5 players per every deck of cards and instructions for the game are as follows:
Object—Add and Subtract, or Add, Subtract, Multiply, and/or Divide or use parentheses, exponents and any legal math operation to collect cards. The player with the most cards is the BIG Winner!Players who have any cards in their stack are Winners!
Deal—4 cards to each player for the player's hand and 1 card to the table. Alternatively, each player may be dealt 5 cards, or six cards, etc.
Play—The table card is turned over. The players try to make its number with the cards they have in hand using either side of a card. Players may use 1, 2, 3 or 4 cards in their hand to make the number of the table card. Players may add, subtract or add, subtract, multiply and/or divide the numbers using 1 face of each card.
Examples—Table card, after it is turned over=4. A player's hand=2/4, 2/5, 8/9, 1/7. The following equations equal 4:4=4; 2×2=4; 9-7=2+2=4; 7+9=16/2=8−4=4; and there are more!
Play—Players may be given a time limit (e.g., 1-3 minutes) to make their equations. When the time is over, the players put their cards down with the numbers of the equations face up. In turn, players state their equations out loud. A player may ask for help from another player, and the player who asked for help collects the cards. Players collect the cards that they have used to make their number.
Next Round—Players take cards from the remainder pack to replace cards they used. The old table card is put on the bottom and a new table card is dealt to the from the top of the remainder pack. The timer can be set and the table card is turned over. Play continues until all the cards in the remainder pack have been used.
Win—The player with the most cards is the BIG Winner! Players who have any cards in their stack are Winners!
LEVEL 2—The same as level 1, but players must use ALL the cards in their hand to make the number of the table card.
LEVEL 3—The same as level 2, but the FIRST player to make the number of the table card using all the cards in the players hand wins the round.
Note—If none of the players can make the number of the table card within the time limit, a new table card is dealt.

It is preferred that the cards in the deck display numbers but the numbers could be replaced by other indicia, for example, animal images, letters, etc., without departing from the spirit and scope of the invention.

Wiz-Dik can also be in the form of a computer program, either stand-alone or as part of a module, as is here with respect to Wiz-Math. As shown in FIG. 25, when a user is logged into Wiz-Math, the user selects Wiz-Dek to access the module. The user makes selections to select a game and invite other players. Cards are displayed in digital format and each player makes selections of desired inputs to play each game.

### Assessment Subsystem

Test grades often indicate not only mastery when the grade is 100%, but also some amount of non-mastery at less than 100%. A grade of 75% is often a passing grade, although it indicates that 25% of the required knowledge has not been mastered. Mathematical concepts are often built on top of a foundation of knowledge. When the foundation has holes, it is difficult and frustrating to understand concepts built upon that foundation. Therefore, it is beneficial to build a strong foundation of mathematical concepts.

The present invention includes a student assessment subsystem that is able to analyze a student's performance and provide feedback to students on how well they performed and where they need to improve. This is done for the student to gain a more holistic understanding of the desirable mathematic subject matter they are learning and know exactly where the student needs to improve. For example, if a student is having difficulty with Algebraic division because the student does not understand fractions, the student assessment subsystem will provide feedback to the student that they do not understand fractions and tells the student to focus on fractions in order to get a holistic understanding of Algebraic division. The student may then request for a self-assessment on that specific area they are having trouble with. The student is thereby directed to sources for further study of the related materials needed to master the subject matter they are having trouble with.

Once the student reviews the materials and improves, they may take a student assessment exam to assess their performance and see their progress in the area they have difficulty with. When the student demonstrates mastery of the area and passes, the student accumulates system credits. However, if the student is unable to prove mastery they are directed to sources of information and assistance that would help the student gain mastery in the student's chosen subject matter. This cycle repeats until the student attains mastery and gains a holistic understanding of the subject matter that they are having trouble with. Upon mastery of the subject matter, the student can accumulate system credits to use for, for example, purchase of Wiz-Blox from other students, as described above.

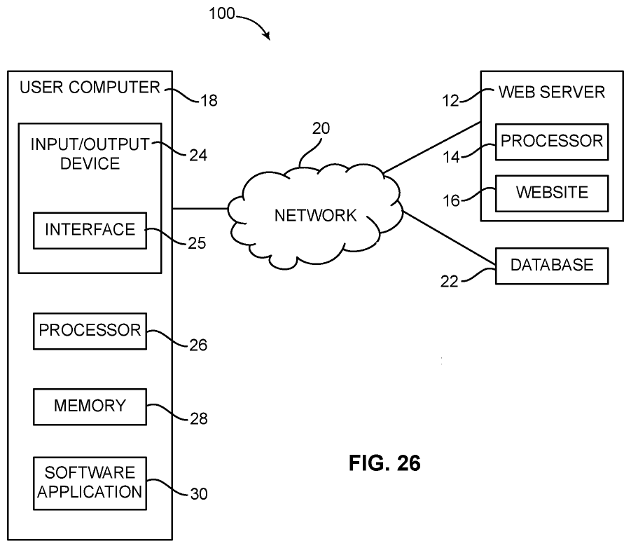

Referring to FIG. 26, a user logs into Wiz-Math 30 on the user's computer 18, which includes an input/output device 24 having an interface 25, processor 26 and memory 28. The user's computer 18 is coupled to a network 20, e.g., internet. A remote server 12 having a processor 14 is coupled to the user's computer 18 via the network 20. Optionally, the server 12 could include a website 16 for Wiz-Math, through which the user could login. A database 22 containing predetermined questions or problems is also coupled to the network 20 for access to the user. As such, a subsystem 100 is provided for evaluating the user's performance. One or more of the plurality of modules are operably coupled thereto, the one or more of the plurality of modules, shown in FIG. 25, are configured to generate pre-determined questions or problems for a user to answer and each answer is evaluated by the subsystem 100 through the server processor 14 for generating a performance score, which is then displayed on the user's computer 18.

Optionally, a pre-determined amount of credit may be provided to the user based on the user's performance score. Such credits could be used by the user in a variety of ways including, using the credits to complete a grade or advance to a higher lever, or to use to purchase goods on Wiz-Math.

Also, in the event that the user's performance score is below a pre-determined threshold, information relevant to the pre-determined questions or problems of which the user requires help could be displayed for the user to review. Additionally, the user could query the application for more information on the subject matter or the application could be programmed such that additional information on the subject matter is automatically displayed for the user to review.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

1. A system for teaching and learning mathematics, the system comprising a plurality of modules including:
a first module having a plurality of blocks for assembling into different configurations, wherein the blocks of the first module comprise blocks of differing geometric shapes, and wherein the blocks comprise at least one isoceles right triangular prism, at least one cube and at least one rhomboid prism;
a second module having a plurality of sheets of predetermined mathematical equations, wherein the sheets of the second module comprise at least addition, subtraction, multiplication, and division operations;
a third module having a plurality of dice having numbers and mathematical operation symbols, wherein the third module comprises three dice, each dice having a plurality of sides, wherein two dice include a number on each side and one dice includes a different mathematical operation symbol on each side, wherein each of the three dice are of different color, and wherein the mathematical operation symbols comprise at least addition, subtraction, multiplication, and division operations; and
a fourth module having a deck of playing cards, wherein the deck of the fourth module comprises fifty-five unique 2-sided playing cards.

2. The system of claim 1, wherein at least one of the modules is implemented with augmented or virtual reality.

3. (canceled)

4. (canceled)

5. (canceled)

6. (canceled)

7. (canceled)

8. (canceled)

9. (canceled)

10. The system of claim 1, further comprising a subsystem for evaluating performance, wherein one or more of the plurality of modules are operably coupled thereto, the one or more of the plurality of modules configured to generate pre-determined questions or problems for a user to answer, each answer evaluated by the subsystem for generating a performance score.

11. A method of teaching and learning mathematics, the method comprising the steps of:
providing a system having a plurality of modules including:
a first module having a plurality of blocks for assembling into different configurations, wherein the blocks of the first module comprise blocks of differing geometric shapes and wherein the blocks comprise at least one isoceles right triangular prism, at least one cube and at least one rhomboid prism,
a second module having a plurality of sheets of predetermined mathematical equations, wherein the sheets of the second module comprise at least addition, subtraction, multiplication, and division operations,
a third module having a plurality of dice having numbers and mathematical operation symbols, wherein the third module comprises three dice, each dice having a plurality of sides, wherein two dice include a number on each side and one dice includes a different mathematical operation symbol on each side, wherein each of the three dice are of different color, and wherein the mathematical operation symbols comprise at least addition, subtraction, multiplication, and division operations, and
a fourth module having a deck of playing cards, wherein the deck of the fourth module comprises fifty-five unique 2-sided playing cards;
selecting the first module and arranging the blocks into a desired configuration;
selecting the second module and referencing a desired predetermined mathematical equation;
selecting the third module and engaging the dice to reference a mathematical equation output; and
selecting the fourth module and playing a predetermined game using the playing cards.

12. The method of claim 11, wherein at least one of the modules is implemented with augmented or virtual reality.

13. (canceled)

14. (canceled)

15. (canceled)

16. (canceled)

17. (canceled)

18. (canceled)

19. (canceled)

20. The method of claim 11, further comprising the steps of:
configuring one or more of the plurality of modules to generate pre-determined questions or problems for a user to answer;
inputting, by a user, an answer to each question or problem;
processing, by a processor, each inputted answer;
generating, by a processor, a performance score; and
displaying the performance score to the user.

21. The method of claim 20, further comprising the step of providing a pre-determined amount of credit to the user based on the user's performance score.

22. The method of claim 20, further comprising the step of displaying to the user information relevant to the pre-determined questions or problems in the event that the user's performance score is below a pre-determined threshold.

23. A non-transitory computer readable medium for teaching and learning mathematics, comprising instructions stored thereon, that when executed on a processor performs the steps of:
receiving an input from a user for selecting at least one of a plurality of modules, wherein the plurality of modules comprises a first module having a plurality of blocks for assembling into different configurations, a second module having a plurality of sheets of predetermined mathematical equations, a third module having a plurality of dice having numbers and mathematical operation symbols, and a fourth module having a deck of playing cards;
executing and displaying the first module, when selected by the user, the plurality of blocks for the user to assemble into a desired configuration;
executing and displaying the second module, when selected by the user, a sheet of predetermined mathematical equations queried by the user;
executing and displaying the third module, when selected by the user, at least one combination of the plurality of dice; and
executing and displaying the fourth module, when selected by the user, at least one game using the playing cards.

24. The non-transitory computer-readable medium of claim 23, wherein at least one of the modules is implemented with augmented or virtual reality.
